(19) United States
(12) Patent Application Publication
(10) Pub. No.: US 2025/0377542 A1
(43) Pub. Date: Dec. 11, 2025

(54) VIRTUAL REALITY SYSTEM

(71) Applicant: ZHEJIANG SUNNY OPTICS CO., LTD., Yuyao City (CN)

(72) Inventors: Zhenzhu LI, Yuyao City (CN); Mengyi FENG, Yuyao City (CN); Kang LI, Yuyao City (CN); Litong SONG, Yuyao City (CN); Weifang LI, Yuyao City (CN); Lin HUANG, Yuyao City (CN); Yinfang JIN, Yuyao City (CN); Liefeng ZHAO, Yuyao City (CN)

(73) Assignee: ZHEJIANG SUNNY OPTICS CO., LTD., Yuyao City (CN)

(21) Appl. No.: 19/230,916

(22) Filed: Jun. 6, 2025

(30) Foreign Application Priority Data
Jun. 7, 2024 (CN) 202410737000.3

(51) Int. Cl. G02B 27/01; G02B 3/00; G02B 5/30

(52) U.S. Cl. CPC G02B 27/0172; G02B 3/0043; G02B 5/3025; G02B 27/0176; G02B 2027/011; G02B 2027/0123; G02B 2027/015

(57) ABSTRACT

The present application discloses a virtual reality system comprising a first optical system and a second optical system. The first optical system comprises first to fourth element groups in order from a first side to a second side along a first optical axis, wherein the first element group comprises a reflective polarizing element, a quarter-wave plate and a first lens; the second element group comprises a second lens; the third element group comprises a third lens; and the fourth element group comprises a fourth lens. The second optical system comprises first to sixth lens elements in order from an object side to an image side along a second optical axis, wherein the first, fourth and sixth lens elements have a negative refractive power; and the second, third and fifth lens elements have a positive refractive power. The maximum field of view FOVX of the second optical system and the maximum field of view FOVY of the first optical system satisfy: 1<FOVX/FOVY<1.6.

### CROSS-REFERENCE TO RELATED APPLICATIONS

The present application claims the priority of Chinese patent application No. 202410737000.3, filed on Jun. 7, 2024, which is hereby incorporated by reference in its entirety.

### TECHNICAL FIELD

The present application relates to the field of optical devices, and in particular to a virtual reality system.

### BACKGROUND

With the rapid development of virtual reality technology, virtual reality apparatuses are widely used in various fields. In order to enhance the immersion of virtual reality apparatuses and improve user experience, more and more optical systems with different functions are applied to virtual reality apparatuses. Generally, a virtual reality apparatus includes a visual system for providing a sense of immersion, a positioning system for capturing actions, a perspective system for interacting with reality, a facial recognition system for constructing expressions, etc. Complex virtual reality apparatuses significantly enhance the virtual reality experience of users.

At present, there is a virtual reality apparatus that includes a visual system and a perspective system, in which the visual system can lead a user into a virtual world, giving the user a sense of immersion; and at the same time, it is combined with the perspective system to enable the interaction between the virtual world and a real world to be implemented. However, due to the demand for miniaturization and lightweight, the current virtual reality apparatus makes it difficult to balance the visual projection quality and the perspective system's ability to capture real-time images with its own size. In addition, the perspective system has a small field of view, which seriously affects the user experience. Therefore, it is necessary to further optimize the architecture of the visual system and the perspective system, which can reduce its own size while taking into account the optimization of key dimensions such as the field of view of the system, so as to solve the problems of large size and small field of view existing in the current virtual reality apparatus.

### SUMMARY

The present application provides a virtual reality system that can at least solve or partially solve at least one problem or other problems existing in the prior art.

In an aspect, the present application provides a virtual reality system, which may include a first optical system and a second optical system, wherein the first optical system comprises a first element group, a second element group, a third element group and a fourth element group in order from a first side to a second side along a first optical axis, wherein the first element group comprises a reflective polarizing element, a quarter-wave plate and a first lens; the second element group comprises a second lens; the third element group comprises a third lens; the fourth element group comprises a fourth lens; the second optical system comprises a first lens element, a second lens element, a third lens element, a fourth lens element, a fifth lens element and a sixth lens element in order from an object side to an image side along a second optical axis, wherein the first lens element, the fourth lens element and the sixth lens element have a negative refractive power; the second lens element, the third lens element and the fifth lens element have a positive refractive power; and the virtual reality system satisfies: 1<FOVX/FOVY<1.6, wherein FOVX is a maximum field of view of the second optical system, and FOVY is a maximum field of view of the first optical system.

According to an exemplary implementation of the present application, a sum ΣCTY of center thicknesses of the first lens, the second lens, the third lens and the fourth lens in the first optical system on the first optical axis and a sum ΣCTX of center thicknesses of the first lens element, the second lens element, the third lens element, the fourth lens element, the fifth lens element and the sixth lens element in the second optical system on the second optical axis satisfy: 2.9<ΣCTY/ΣCTX<3.5.

According to an exemplary implementation of the present application, a center thickness CT1Y of the first lens in the first optical system on the first optical axis, a center thickness CTRA of the reflective polarizing element in the first optical system on the first optical axis, and a center thickness CTQA of the quarter-wave plate in the first optical system on the first optical axis satisfy: 1<CT1Y/(CTRA+CTQA)<3.6.

According to an exemplary implementation of the present application, a radius of curvature R3X of an object side surface of the second lens element in the second optical system, a radius of curvature R4X of an image side surface of the second lens element in the second optical system, and an effective focal length f2X of the second lens element in the second optical system satisfy: 0.6<R3X/R4X<1.8, and −13.2<f2X/R3X<−2.

According to an exemplary implementation of the present application, among the first to fourth lenses of the first optical system, the fourth lens has the largest center thickness on the first optical axis, and the center thickness CT4Y of the fourth lens on the first optical axis and a center thickness CT3Y of the third lens on the first optical axis satisfy:

$$2.5 < CT 4 Y / CT 3 Y < 4.5 .$$

According to an exemplary implementation of the present application, in the second optical system, an effective focal length f6X of the sixth lens element, a radius of curvature R11X of an object side surface of the sixth lens element, and a radius of curvature R12X of an image side surface of the sixth lens element satisfy: 0<f6X/R11X<1.5, and −2<f6X/R12X<−0.2.

According to an exemplary implementation of the present application, an effective focal length f2Y of the second lens in the first optical system and an effective focal length f4Y of the fourth lens satisfy: 0.2<f2Y/f4Y<1.8.

According to an exemplary implementation of the present application, a dispersion coefficient VNY of any lens in the first optical system satisfies: 15<VNY<30.

According to an exemplary implementation of the present application, among the first to sixth lens elements of the second optical system, the fifth lens element has the largest center thickness on the second optical axis, and the center thickness CT5X of the fifth lens element on the second optical axis, an air spacing T56X between the fifth lens element and the sixth lens element on the second optical axis, and a center thickness CT6X of the sixth lens element on the second optical axis satisfy: 0.8<CT5X/(T56X+CT6X)<1.5.

According to an exemplary implementation of the present application, a combined focal length f56X of the fifth lens element and the sixth lens element in the second optical system, and an effective focal length f4X of the fourth lens element satisfy: −2<f56X/f4X<−1.

According to an exemplary implementation of the present application, an entrance pupil diameter EPDY of the first optical system and an entrance pupil diameter EPDX of the second optical system satisfy: 3.9<EPDY/EPDX<4.2.

According to an exemplary implementation of the present application, an effective focal length f5X of the fifth lens element in the second optical system and a center thickness CT5X of the fifth lens element on the second optical axis satisfy: 1.5<f5X/CT5X<2.8.

According to an exemplary implementation of the present application, in the first optical system, a center thickness CT2Y of the second lens on the first optical axis, an air spacing T12Y between the first lens and the second lens on the first optical axis, and an air spacing T23Y between the second lens and the third lens on the first optical axis satisfy:

$$3 < CT 2 Y / ( T 12 Y + T 23 Y ) < 21.$$

According to an exemplary implementation of the present application, in the second optical system, an effective focal length f3X of the third lens element, a center thickness CT3X of the third lens element on the second optical axis, a radius of curvature R5X of an object side surface of the third lens element and a radius of curvature R6X of an image side surface of the third lens element satisfy: 1.5<f3X/CT3X<3.5, and −1.5<R5X/R6X<−0.2.

According to an exemplary implementation of the present application, in the first optical system, a first side surface of the first lens is closely fitted to the quarter-wave plate, and a second side surface of the reflective polarizing element is closely fitted to the quarter-wave plate.

In another aspect, the present application further provides a virtual reality system, which may include a first optical system and a second optical system, wherein the first optical system comprises a first element group, a second element group, a third element group and a fourth element group in order from a first side to a second side along a first optical axis, wherein the first element group comprises a reflective polarizing element, a quarter-wave plate and a first lens; the second element group comprises a second lens; the third element group comprises a third lens; the fourth element group comprises a fourth lens; the second optical system comprises a first lens element, a second lens element, a third lens element, a fourth lens element, a fifth lens element and a sixth lens element in order from an object side to an image side along a second optical axis, wherein the first lens element, the fourth lens element and the sixth lens element have a negative refractive power; the second lens element, the third lens element and the fifth lens element have a positive refractive power; and the virtual reality system satisfies: 2.3<TDY/TDX<2.8, and 0.5<ΣATX/ΣATY<2, where TDY is a distance from a first side surface of the first element group in the first optical system to a second side surface of the fourth element group on the first optical axis, TDX is a distance from an object side surface of the first lens element in the second optical system to an image side surface of the sixth lens element on the second optical axis, ΣATY is a sum of air spacings between any two adjacent lenses having a refractive power in the first optical system on the first optical axis, and ΣATX is a sum of air spacings between any two adjacent lens elements having a refractive power in the second optical system on the second optical axis.

According to an exemplary implementation of the present application, a sum ΣCTY of center thicknesses of the first lens, the second lens, the third lens and the fourth lens in the first optical system on the first optical axis and a sum ΣCTX of center thicknesses of the first lens element, the second lens element, the third lens element, the fourth lens element, the fifth lens element and the sixth lens element in the second optical system on the second optical axis satisfy: 2.9<ΣCTY/ΣCTX<3.5.

According to an exemplary implementation of the present application, a center thickness CT1Y of the first lens in the first optical system on the first optical axis, a center thickness CTRA of the reflective polarizing element in the first optical system on the first optical axis, and a center thickness CTQA of the quarter-wave plate in the first optical system on the first optical axis satisfy: 1<CT1Y/(CTRA+CTQA)<3.6.

According to an exemplary implementation of the present application, a radius of curvature R3X of an object side surface of the second lens element in the second optical system, a radius of curvature R4X of an image side surface of the second lens element in the second optical system, and an effective focal length f2X of the second lens element in the second optical system satisfy: 0.6<R3X/R4X<1.8, and −13.2<f2X/R3X<−2.

According to an exemplary implementation of the present application, among the first to fourth lenses of the first optical system, the fourth lens has the largest center thickness on the first optical axis, and the center thickness CT4Y of the fourth lens on the first optical axis and a center thickness CT3Y of the third lens on the first optical axis satisfy:

$$2.5 < CT 4 Y / CT 3 Y < 4.5 .$$

According to an exemplary implementation of the present application, in the second optical system, an effective focal length f6X of the sixth lens element, a radius of curvature R11X of an object side surface of the sixth lens element, and a radius of curvature R12X of an image side surface of the sixth lens element satisfy: 0<f6X/R11X<1.5, and −2<f6X/R12X<−0.2.

According to an exemplary implementation of the present application, an effective focal length f2Y of the second lens in the first optical system and an effective focal length f4Y of the fourth lens satisfy: 0.2<f2Y/f4Y<1.8.

According to an exemplary implementation of the present application, a dispersion coefficient VNY of any lens in the first optical system satisfies: 15<VNY<30.

According to an exemplary implementation of the present application, among the first to sixth lens elements of the second optical system, the fifth lens element has the largest center thickness on the second optical axis, and the center thickness CT5X of the fifth lens element on the second optical axis, an air spacing T56X between the fifth lens element and the sixth lens element on the second optical axis, and a center thickness CT6X of the sixth lens element on the second optical axis satisfy: 0.8<CT5X/(T56X+CT6X)<1.5.

According to an exemplary implementation of the present application, a combined focal length f56X of the fifth lens element and the sixth lens element in the second optical system, and an effective focal length f4X of the fourth lens element satisfy: −2<f56X/f4X<−1.

According to an exemplary implementation of the present application, an entrance pupil diameter EPDY of the first optical system and an entrance pupil diameter EPDX of the second optical system satisfy: 3.9<EPDY/EPDX<4.2.

According to an exemplary implementation of the present application, an effective focal length f5X of the fifth lens element in the second optical system and a center thickness CT5X of the fifth lens element on the second optical axis satisfy: 1.5<f5X/CT5X<2.8.

According to an exemplary implementation of the present application, in the first optical system, a center thickness CT2Y of the second lens on the first optical axis, an air spacing T12Y between the first lens and the second lens on the first optical axis, and an air spacing T23Y between the second lens and the third lens on the first optical axis satisfy:

$$3 < CT 2 Y / ( T 12 Y + T 23 Y ) < 21.$$

According to an exemplary implementation of the present application, in the second optical system, an effective focal length f3X of the third lens element, a center thickness CT3X of the third lens element on the second optical axis, a radius of curvature R5X of an object side surface of the third lens element and a radius of curvature R6X of an image side surface of the third lens element satisfy: 1.5<f3X/CT3X<3.5, and −1.5<R5X/R6X<−0.2.

According to an exemplary implementation of the present application, in the first optical system, a first side surface of the first lens is closely fitted to the quarter-wave plate, and a second side surface of the reflective polarizing element is closely fitted to the quarter-wave plate.

The virtual reality system provided by the present application may comprise the first optical system and the second optical system, wherein the first optical system may include the first to fourth element groups in order from the first side to the second side along the first optical axis, the first element group comprises the reflective polarizing element, the quarter-wave plate and the first lens; the second element group comprises the second lens; the third element group comprises the third lens; the fourth element group comprises the fourth lens; the second optical system may comprise first to sixth lens elements in order from the object side to the image side along the second optical axis, wherein the first, fourth and sixth lens elements have a negative refractive power, and the second, third and fifth lens elements have a positive refractive power; and the maximum field of view FOVX of the second optical system and the maximum field of view FOVY of the first optical system may satisfy the conditional expression of 1<FOVX/FOVY<1.6. By reasonably setting the basic architecture of the first optical system and the second optical system, and controlling the ratio of the maximum field of view of the second optical system to the maximum field of view of the first optical system, the field of view of the second optical system is made greater than the field of view of the first optical system, which is advantageous for improving the overall performance and increasing the user experience.

### BRIEF DESCRIPTION OF THE DRAWINGS

Other features, objectives, and advantages of the present application will become more apparent from the following detailed description of implementations with reference to the drawings. In the drawings:

FIG. 1 shows a schematic plan view of a virtual reality system according to the present application;

FIG. 2 shows a schematic structural diagram of a first optical system according to Embodiment 1 of the present application and a schematic diagram of some light rays being deflected by the first optical system;

FIGS. 3, 4 and 5 show an astigmatism curve, a distortion curve and a longitudinal aberration curve of the first optical system according to Embodiment 1 of the present application, respectively;

FIG. 6 shows a schematic structural diagram of a first optical system according to Embodiment 2 of the present application and a schematic diagram of some light rays being deflected by the first optical system;

FIGS. 7, 8 and 9 show an astigmatism curve, a distortion curve and a longitudinal aberration curve of the first optical system according to Embodiment 2 of the present application, respectively;

FIG. 10 shows a schematic structural diagram of a first optical system according to Embodiment 3 of the present application and a schematic diagram of some light rays being deflected by the first optical system;

FIGS. 11, 12 and 13 show an astigmatism curve, a distortion curve and a longitudinal aberration curve of the first optical system according to Embodiment 3 of the present application, respectively;

FIG. 14 shows a schematic structural diagram of a first optical system according to Embodiment 4 of the present application and a schematic diagram of some light rays being deflected by the first optical system;

FIGS. 15, 16 and 17 show an astigmatism curve, a distortion curve and a longitudinal aberration curve of the first optical system according to Embodiment 4 of the present application, respectively;

FIG. 18 shows a schematic structural diagram of a second optical system according to Embodiment 5 of the present application;

FIGS. 19, 20 and 21 show a longitudinal aberration curve, a distortion curve and an astigmatism curve of the second optical system according to Embodiment 5 of the present application, respectively;

FIG. 22 shows a schematic structural diagram of a second optical system according to Embodiment 6 of the present application;

FIGS. 23, 24 and 25 show a longitudinal aberration curve, a distortion curve and an astigmatism curve of the second optical system according to Embodiment 6 of the present application, respectively;

FIG. 26 shows a schematic structural diagram of a second optical system according to Embodiment 7 of the present application;

FIGS. 27, 28 and 29 show a longitudinal aberration curve, a distortion curve and an astigmatism curve of the second optical system according to Embodiment 7 of the present application, respectively;

FIG. 30 shows a schematic structural diagram of a second optical system according to Embodiment 8 of the present application; and

FIGS. 31, 32 and 33 show a longitudinal aberration curve, a distortion curve and an astigmatism curve of the second optical system according to Embodiment 8 of the present application, respectively.

### DETAILED DESCRIPTION

In order to better understand the present application, various aspects of the present application will be described in more detail with reference to the drawings. It should be understood that the detailed description is merely a description of exemplary implementations of the present application, and does not limit the scope of the present application in any way. Throughout the description, the same reference signs refer to the same elements.

It should be noted that in this specification, the expressions of “first”, “second”, “third” etc. are only used to distinguish one feature from another feature, and do not indicate any limitation on the feature. Therefore, without departing from the teachings of the present application, a first lens discussed below may also be referred to as a second lens or a third lens.

In the drawings, for convenience of explanation, the thickness, size, and shape of lenses and/or lens elements have been slightly exaggerated. Specifically, the shapes of spherical or aspherical surfaces shown in the drawings are shown by way of example. That is, the shapes of the spherical or aspherical surfaces are not limited to those shown in the drawings. The drawings are only examples and are not drawn strictly to scale.

Herein, a paraxial region refers to a region near an optical axis. If a surface of a lens and/or a lens element is convex and the position of the respective convex surface is not defined, then it means that the surface of the lens and/or the lens element is convex at least in the paraxial region; and if a surface of a lens and/or a lens element is concave and the position of the respective concave surface is not defined, then it means that the surface of the lens and/or the lens element is concave at least in the paraxial region. A surface of each lens closest to a first side (such as a human eye side) is referred as a first side surface of the lens, and a surface of each lens closest to a second side (such as a display screen side) is referred as a second side surface of the lens. A surface of each lens element closest to a subject (=an object to be captured) is referred as an object side surface of the lens element, and a surface of each lens element closest to an imaging plane is referred as an image side surface of the lens element.

It should also be understood that the terms “comprising”, “comprise”, “having”, “including” and/or “include” when used in this specification, indicate the existence of stated features, elements and/or components, but does not exclude the presence or addition of one or more other features, elements, components and/or combinations thereof. In addition, when an implementation of the present application is described, “may” is used to indicate “one or more implementations of the present application”. Also, the term “exemplary” is intended to refer to an example or illustration.

Unless otherwise defined, all terms (including technical and scientific terms) used herein have the same meanings as commonly understood by those of ordinary skill in the art to which the present application belongs. It should also be understood that the terms (such as those defined in commonly used dictionaries) should be interpreted to have meanings consistent with their meanings in the context of the relevant art and will not be interpreted in an idealized or overly significance formal sense unless it is clearly defined herein.

It should be noted that, in the case of no conflict, the embodiments in the present application and the features in the embodiments may be combined with each other. The present application will be described in detail below in conjunction with embodiments with reference to the drawings.

The features, principles and other aspects of the present application will be described in detail below.

A virtual reality system according to an exemplary implementation of the present application may include a first optical system and a second optical system.

In an exemplary implementation, the first optical system may include a first element group, a second element group, a third element group, and a fourth element group arranged in order from a first side to a second side along a first optical axis. The first element group may include a reflective polarizing element, a quarter-wave plate, and a first lens. The second element group may include a second lens. The third element group may include a third lens. The fourth element group may include a fourth lens.

In an exemplary implementation, the second optical system may include a first lens element, a second lens element, a third lens element, a fourth lens element, a fifth lens element and a sixth lens element arranged in order from an object side to an image side along a second optical axis, wherein the first lens element, the fourth lens element and the sixth lens element may have a negative refractive power, and the second lens element, the third lens element and the fifth lens element may have a positive refractive power.

In an exemplary implementation, the virtual reality system of the present application may satisfy a conditional expression of 1<FOVX/FOVY<1.6, where FOVX is the maximum field of view of the second optical system, and FOVY is the maximum field of view of the first optical system.

The virtual reality system provided according to the present application includes the first optical system and the second optical system. By reasonably setting the basic structures of the first optical system and the second optical system, the first optical system is configured to include the first to fourth element groups in order from the first side to the second side along the first optical axis, the first element group including the reflective polarizing element, the quarter-wave plate and the first lens, the second element group including the second lens, the third element group including the third lens, and the fourth element group including the fourth lens; and the second optical system is configured to include the first to sixth lens elements in order from the object side to the image side along the second optical axis, wherein the first, fourth and sixth lens elements have a negative refractive power, and the second, third and fifth lens elements have a positive refractive power. Moreover, the maximum field of view FOVX of the second optical system and the maximum field of view FOVY of the first optical system are reasonably controlled to satisfy the conditional expression of 1<FOVX/FOVY<1.6. The field of view of the second optical system is made greater than the field of view of the first optical system, which is advantageous for improving the overall performance and increasing the user experience.

In an exemplary implementation, the virtual reality system of the present application may satisfy a conditional expression of 2.3<TDY/TDX<2.8, where TDY is the distance from the first side surface of the first element group in the first optical system to the second side surface of the fourth element group on the first optical axis, and TDX is the distance from the object side surface of the first lens element in the second optical system to the image side surface of the sixth lens element on the second optical axis.

In an exemplary implementation, the virtual reality system of the present application may satisfy a conditional expression of 0.5<ΣATX/ΣATY<2, where ΣATX is the sum of air spacings between any two adjacent lens elements having the refractive power in the second optical system on the second optical axis, and ΣATY is the sum of air spacings between any two adjacent lenses having the refractive power in the first optical system on the first optical axis.

The virtual reality system provided according to the present application includes the first optical system and the second optical system. By reasonably setting the basic structures of the first optical system and the second optical system, the first optical system is configured to include the first to fourth element groups in order from the first side to the second side along the first optical axis, the first element group including the reflective polarizing element, the quarter-wave plate and the first lens, the second element group including the second lens, the third element group including the third lens, and the fourth element group including the fourth lens; and the second optical system is configured to include the first to sixth lens elements in order from the object side to the image side along a second optical axis, wherein the first, fourth and sixth lens elements have a negative refractive power, and the second, third and fifth lens elements have a positive refractive power. Moreover, the ratio of the distance TDY, from the first side surface of the first element group in the first optical system to the second side surface of the fourth element group on the first optical axis, to the distance TDX, from the object side surface of the first lens element in the second optical system to the image side surface of the sixth lens element on the second optical axis, is reasonably controlled to satisfy the conditional expression of 2.3<TDY/TDX<2.8. Meanwhile, the ratio of the sum ΣATX of the air spacings between any two adjacent lens elements having the refractive power in the second optical system on the second optical axis to the sum of the air spacings ΣATY between any two adjacent lenses having the refractive power in the first optical system on the first optical axis is reasonably controlled to satisfy the conditional expression of 0.5<ΣATX/ΣATY<2, which can be advantageous for reducing the total length of the visual system and the perspective system, facilitating the layout of the entire machine and making the equipment lighter and thinner while making the system more compact.

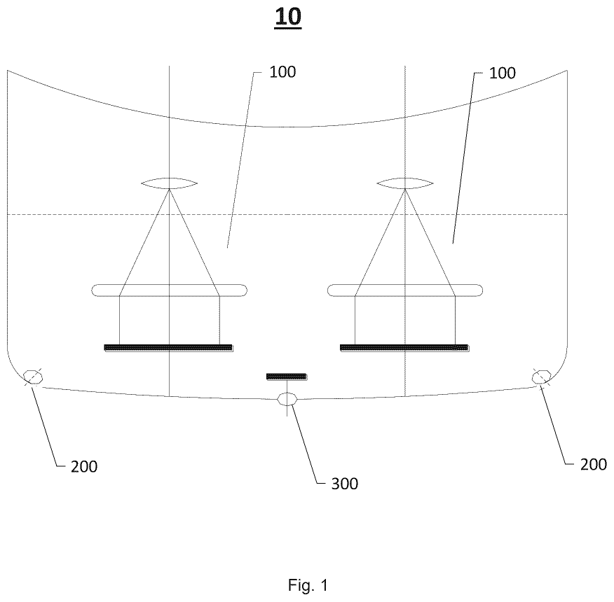

Referring to FIG. 1, in an exemplary implementation, the virtual reality system 10 provided by the present application may include a first optical system 100 and a second optical system 200. The second optical system 200 may be used, for example, to image a real scene, and a real image formed may be transmitted to the first optical system 100 in the form of an electrical signal, for example. The first optical system 100 may be used to project a virtual image on a display or an image plane IMG disposed on the second side and the above real image formed by the second optical system 200 transmitted to the display or the image plane IMG. By combining the first optical system 100 and the second optical system 200, the virtual reality fusion of the virtual reality system 10 may be achieved. The first optical system 100 may be configured as a catadioptric optical system, the number of which may be one or more, and the second optical system 200 may be configured as a transmissive optical system, the number of which may be one or more. In one example, the virtual reality system 10 may include two first optical systems 100 disposed symmetrically. In one example, the virtual reality system 10 further includes a body, the first optical system 100 may be disposed on the inner side of the body, and the second optical system 200 may be disposed on the outer side of the body.

In an exemplary implementation, the first side may be a near-eye side, and the second side may be a display side. Correspondingly, the first side surface of each element such as the reflective polarizing element, the quarter-wave plate, the first lens, the second lens, the third lens, the fourth lens, etc. in the first optical system may also be referred to as a near-eye side surface, and the second side surface may also be referred to as a near-display side surface. Correspondingly, each of the first to sixth lens elements in the second optical system also has at least a surface relatively close to the near-eye side and a surface relatively close to the display side.

In an exemplary implementation, the first optical system may further include a partial reflective element, which may be disposed, for example, on the second side surface of the fourth lens. The partial reflective element has a semi-transmissive and semi-reflective effect on light. By arranging the partial reflective element on, for example, the second side surface of the fourth lens, and combining the arrangement of the reflective polarizing element, the quarter-wave plate, etc., the light can be refracted and reflected multiple times in the first optical system, effectively reducing the body length of the first optical system.

In an exemplary implementation, the first optical system may further include a diaphragm, which may be disposed, for example, between the first side (near-eye side) and the first element group. The image light on the display or image plane may eventually be projected to, for example, a user's eyes after multiple refractions and reflections by the fourth lens, the third lens, the second lens, the first lens, the quarter-wave plate, the reflective polarizing element, etc.

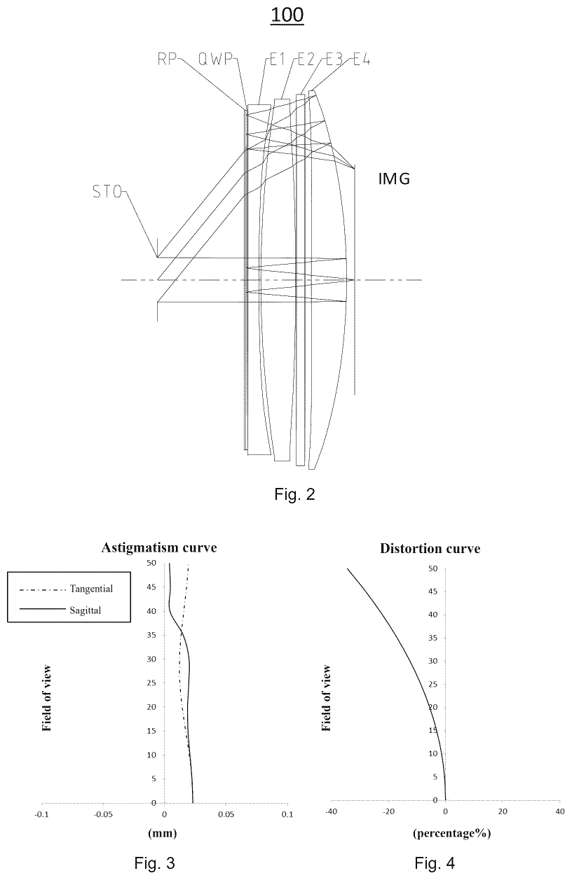

Referring to FIG. 2, in an exemplary implementation, a display or an image plane (IMG) is provided on the second side of the first optical system 100. Image light from the display or the image plane may sequentially pass through a partial reflection element (not shown in the figure), a fourth lens E4, a third lens E3, a second lens E2, a first lens E1, and a quarter-wave plate QWP to reach a reflective polarizing element RP, and then be reflected at the reflective polarizing element RP, to form a first reflected image light. The first reflected image light then sequentially passes through the quarter-wave plate QWP, the first lens E1, the second lens E2, the third lens E3, and the fourth lens E4 to reach a partial reflection element BS, and then be reflected at the partial reflection element BS, to form a second reflected image light. The second reflected image light then sequentially passes through the fourth lens E4, the third lens E3, the second lens E2, the first lens E1, the quarter-wave plate QWP, and the reflective polarizing element RP to a diaphragm STO and is eventually projected into the user's eyes. In other examples, the order in which the image light, the first reflected image light, and the second reflected image light pass through the respective elements may be adjusted as needed. The first optical system provided by the present application folds the required optical path without affecting the projection quality by combining light reflection and refraction, thereby effectively shortening the body length of the first optical system.

In the virtual reality system according to the exemplary implementation of the present application, the first optical system may be used to transmit the virtual image/virtual reality image of the display to the user's eyes, which can give the user a sense of virtual immersion. The second optical system may be used to image the real scene, and transmit the formed real image to the display through, for example, a chip of the second optical system, and the first optical system then transmits the real image on the display to the user. By projecting, with the first optical system, the virtual image on the display screen and the real image formed by the second optical system, the spatial limitation of virtual reality can be broken, and the interaction between the real world and the virtual world of the virtual apparatus can be realized, so that the user can watch the image fused by the virtual picture and the real scene, thereby improving the visual immersion of the virtual reality system.

In an exemplary implementation, the virtual reality system of the present application may satisfy a conditional expression of 2.9<ΣCTY/ΣCTX<3.5, where ΣCTY is the sum of the center thicknesses of the first lens, the second lens, the third lens, and the fourth lens in the first optical system on the first optical axis, and ΣCTX is the sum of the center thicknesses of the first lens element, the second lens element, the third lens element, the fourth lens element, the fifth lens element and the sixth lens element in the second optical system on the second optical axis. By reasonably controlling this conditional expression, the volume proportion of the two optical systems can be controlled, which is advantageous for constraining the overall size of the two systems and ensuring the coordinated use effect of the two optical systems.

In an exemplary implementation, the virtual reality system of the present application may satisfy a conditional expression of 1<CT1Y/(CTRA+CTQA)<3.6, where CT1Y is the center thickness of the first lens in the first optical system on the first optical axis, CTRA is the center thickness of the reflective polarizing element in the first optical system on the first optical axis, and CTQA is the center thickness of the quarter-wave plate in the first optical system on the first optical axis. By reasonably controlling this conditional expression, the center thicknesses of the first lens, the reflective polarizing element, and the quarter-wave plate of the first optical system can be reasonably distributed, which is advantageous for controlling the catadioptric path length of the polarized light.

In an exemplary implementation, the virtual reality system of the present application may satisfy a conditional expressions of 0.6<R3X/R4X<1.8 and −13.2<f2X/R3X<−2, where R3X is the radius of curvature of the object side surface of the second lens element in the second optical system, R4X is the radius of curvature of the image side surface of the second lens element in the second optical system, and f2X is the effective focal length of the second lens element in the second optical system. By controlling the ratio of the radius of curvature of the object side surface of the second lens element in the second optical system to the radius of curvature of the image side surface, it is advantageous for standardizing the shape and refracting power of the second lens element. By controlling the ratio of the effective focal length of the second lens element in the second optical system to the radius of curvature of its object side surface, the second lens element is made to have a positive diopter, which is convenient for subsequent aberration optimization so as to improve the optical positioning accuracy. More specifically, R3X and R4X may further satisfy 0.9<R3X/R4X<1.7.

In an exemplary implementation, among the first to fourth lenses of the first optical system, the center thickness of the fourth lens on the first optical axis is the largest, and the center thickness CT4Y of the fourth lens on the first optical axis and the center thickness CT3Y of the third lens on the first optical axis may satisfy a conditional expression of 2.5<CT4Y/CT3Y<4.5. By controlling this conditional expression, it is advantageous for adjusting the chromatic aberration of the visual system (first optical system), thereby ensuring that the visual system has a good imaging effect.

In an exemplary implementation, the virtual reality system of the present application may satisfy a conditional expressions of 0<f6X/R11X<1.5 and −2<f6X/R12X<−0.2, where f6X is the effective focal length of the sixth lens element in the second optical system, R11X is the radius of curvature of the object side surface of the sixth lens element in the second optical system, and R12X is the radius of curvature of the image side surface of the sixth lens element in the second optical system. By controlling the ratio of the effective focal length of the sixth lens element in the second optical system to the radius of curvature of each of the object side surface and the image side surface of the sixth lens element to satisfy the above relationships, light of the edge field of view can be more converged while ensuring the manufacturability of the sixth lens element, which is advantageous for correcting the aberration of the system and improving the imaging quality.

In an exemplary implementation, the virtual reality system of the present application may satisfy a conditional expression of 0.2<f2Y/f4Y<1.8, where f2Y is the effective focal length of the second lens in the first optical system, and f4Y is the effective focal length of the fourth lens in the first optical system. By controlling the ratio between the effective focal lengths of the second lens and the fourth lens in the first optical system to be within this range, it is advantageous for the distribution of the focal lengths of the second lens and the fourth lens, thereby ensuring that the second lens and the fourth lens have good light bending capabilities.

In an exemplary implementation, the virtual reality system of the present application may satisfy a conditional expression of 15<VNY<30, where VNY is a dispersion coefficient of any one of the first to fourth lenses in the first optical system. By controlling the above conditional expression, the dispersion coefficient of the visual system (first optical system) can be reasonably adjusted, which is advantageous for improving the chromatic aberration of the visual system, thereby improving the system performance.

In an exemplary implementation, among the first to sixth lens elements of the second optical system, the fifth lens element has the largest center thickness on the second optical axis, and the center thickness CT5X of the fifth lens element on the second optical axis, an air spacing T56X between the fifth lens element and the sixth lens element on the second optical axis, and the center thickness CT6X of the sixth lens element on the second optical axis may satisfy a conditional expression of 0.8<CT5X/(T56X+CT6X)<1.5. By controlling the above conditional expression, the positions of the fifth lens element and the sixth lens element in the second optical system can be reasonably distributed, the interference can be avoided on the basis of making the lens elements satisfy assembling conditions, and the total optical length of the second optical system can also be reduced, which is advantageous for miniaturization of the virtual reality apparatus.

In an exemplary implementation, the virtual reality system of the present application may satisfy a conditional expression of −2<f56X/f4X<−1, wherein f56X is the combined focal length of the fifth lens element and the sixth lens element in the second optical system, and f4X is the effective focal length of the fourth lens element in the second optical system. By controlling the ratio of the combined focal length of the fifth lens element and the sixth lens element in the second optical system to the effective focal length of the fourth lens element within this range, it is advantageous for the focal length distribution and focal length connection of the perspective system (second optical system), which facilitates the reasonable transmission of light to the receiving image plane, and avoids the occurrence of large vignetting that causes a decrease in image brightness.

In an exemplary implementation, the virtual reality system of the present application may satisfy a conditional expression of 3.9<EPDY/EPDX<4.2, where EPDY is the entrance pupil diameter of the first optical system, and EPDX is the entrance pupil diameter of the second optical system. By controlling the ratio of the entrance pupil diameter of the first optical system to the entrance pupil diameter of the second optical system within this range, the entrance pupil diameter of the first system is larger and the entrance pupil diameter of the second system is smaller. On the one hand, it is advantageous for ensuring the light throughput of the visual system and preventing the projection image entering the human eye after polarization transmission from being too dark, thereby affecting the visual experience. Meanwhile, the small aperture design of the perspective lens assembly is preliminarily confirmed to obtain a deeper depth-of-field effect and retain more shooting details, so as to ensure the real-time capture function of the second optical system in a dark light environment.

In an exemplary implementation, the virtual reality system of the present application may satisfy a conditional expression of 1.5<f5X/CT5X<2.8, wherein f5X is the effective focal length of the fifth lens element in the second optical system, and CT5X is the center thickness of the fifth lens element on the second optical axis. By controlling the ratio of the effective focal length of the fifth lens element in the second optical system to its center thickness within this range, it is advantageous for further constraining the surface shape on the basis of ensuring its assembling strength, thereby facilitating diopter distribution.

In an exemplary implementation, the virtual reality system of the present application may satisfy a conditional expression of 3<CT2Y/(T12Y+T23Y)<21, wherein CT2Y is the center thickness of the second lens in the first optical system on the first optical axis, T12Y is the air spacing between the first lens and the second lens in the first optical system on the first optical axis, and T23Y is the air spacing between the second lens and the third lens in the first optical system on the first optical axis. By controlling the above conditional expression, it can be ensured that the second lens of the first optical system has good manufacturability, and that the visual system has a reasonable total optical length, which is advantageous for the miniaturization of the visual system.

In an exemplary implementation, the virtual reality system of the present application may satisfy a conditional expression of 1.5<f3X/CT3X<3.5 and −1.5<R5X/R6X<−0.2, wherein f3X is the effective focal length of the third lens element in the second optical system, CT3X is the center thickness of the third lens element on the second optical axis, R5X is the radius of curvature of the object side surface of the third lens element, and R6X is the radius of curvature of the image side surface of the third lens element. By controlling the above conditional expression, it is advantageous that the third lens element has a positive refractive power on the basis of ensuring the molding process of the third lens element in the second optical system, and the radius of curvature of each of the object side surface and the image side surface of the third lens element in the second optical system can be constrained within a certain range, which is advantageous for reducing the surface profile sensitivity of the third lens element and reducing the manufacturing difficulty of the third lens element.

In an exemplary implementation, the first side surface of the first lens in the first optical system is closely fitted to the quarter-wave plate, and the second side surface of the reflective polarizing element is closely fitted to the quarter-wave plate. That is, in the first optical system, the reflective polarizing element, the quarter-wave plate, and the first lens are arranged in order from the first side to the second side along the first optical axis, the second side surface of the reflective polarizing element is closely fitted to the first side surface of the quarter-wave plate, and the second side surface of the quarter-wave plate is closely fitted to the first side surface of the first lens. In an exemplary implementation, the first side surface of the first lens may be a planar surface or a curved surface. This arrangement of the reflective polarizing element, the quarter-wave plate, and the first lens is advantageous for shortening the length of the visual system and making the equipment thinner and lighter.

The virtual reality system according to the above implementation of the present application is composed of a first optical system and a second optical system, wherein the first optical system may use multiple lenses, such as the four lenses described above, and the second optical system may use multiple lens elements, such as the six lens elements described above. By reasonably configuring the parameters of the first optical system and the second optical system, the system performance can be improved, and the imaging quality and visual immersion of the virtual reality system can be improved. The first optical system and the second optical system are matched together, which can enhance the effectiveness of interaction with reality, and can greatly improve the user experience. Moreover, the virtual reality system configured as above has the characteristics of miniaturization, large field of view and good imaging quality, and so on, which can better meet the use requirements of various portable electronic products in projection scenarios.

In an implementation of the present application, at least one of the lens surfaces of each lens from the first lens to the fourth lens in the first optical system may be an aspherical lens surface. The characteristic of an aspherical lens is that the curvature changes continuously from the center of the lens to the periphery of the lens. Unlike a spherical lens having a constant curvature from the center of the lens to the periphery of the lens, the aspherical lens has a better curvature radius characteristic, and has the advantages of improving distortion aberration and improving astigmatism aberration. After an aspherical lens is adopted, the aberrations that occur during imaging can be eliminated as much as possible, thereby improving the imaging quality. Similarly, at least one of the lens surfaces of each lens element from the first lens element to the sixth lens element in the second optical system may also be an aspherical lens surface.

However, it should be understood by those skilled in the art that the number of lenses and/or lens elements constituting the optical system can be changed without departing from the technical solution claimed in the present application, to obtain respective results and advantages described in the description.

An aspect of the present application provides a virtual reality system including a first optical system and a second optical system. By reasonably setting the basic structures of the first optical system and the second optical system, the first optical system is configured to include first to fourth element groups in order from a first side to a second side along a first optical axis, the first element group including a reflective polarizing element, a quarter-wave plate and a first lens, the second element group including a second lens, the third element group including a third lens, and the fourth element group including a fourth lens; and the second optical system is configured to include first to sixth lens elements in order from an object side to an image side along a second optical axis, wherein the first, fourth and sixth lens elements have a negative refractive power, and the second, third and fifth lens elements have a positive refractive power. Moreover, the maximum field of view FOVX of the second optical system and the maximum field of view FOVY of the first optical system are reasonably controlled to satisfy a conditional expression of 1<FOVX/FOVY<1.6. The field of view of the second optical system is made greater than the field of view of the first optical system, which is advantageous for improving the overall performance and increasing the user experience.

Another aspect of the present application provides a virtual reality system including a first optical system and a second optical system. By reasonably setting the basic structures of the first optical system and the second optical system, the first optical system is configured to include first to fourth element groups in order from a first side to a second side along a first optical axis, the first element group including a reflective polarizing element, a quarter-wave plate and a first lens, the second element group including a second lens, the third element group including a third lens, and the fourth element group including a fourth lens; and the second optical system is configured to include first to sixth lens elements in order from an object side to an image side along a second optical axis, wherein the first, fourth and sixth lens elements have a negative refractive power, and the second, third and fifth lens elements have a positive refractive power. Moreover, the ratio of the distance TDY, from the first side surface of the first element group in the first optical system to the second side surface of the fourth element group on the first optical axis, to the distance TDX, from the object side surface of the first lens element in the second optical system to the image side surface of the sixth lens element on the second optical axis, is reasonably controlled to satisfy a conditional expression of 2.3<TDY/TDX<2.8. Meanwhile, the ratio of the sum ΣATX of the air spacings between any two adjacent lens elements having the refractive power in the second optical system on the second optical axis to the sum of the air spacings ΣATY between any two adjacent lenses having the refractive power in the first optical system on the first optical axis is reasonably controlled to satisfy a conditional expression of 0.5<ΣATX/ΣATY<2, which can be advantageous for reducing the total length of the visual system and the perspective system, facilitating the layout of the entire machine and making the equipment lighter and thinner while making the system more compact.

Specific embodiments of the first optical system applicable to the above implementations will be further described below with reference to the drawings.

### Embodiment 1

A first optical system according to Embodiment 1 of the present application will be described below with reference to FIGS. 2 to 5.

As shown in FIG. 2, the first optical system 100 includes a reflective polarizing element RP, a quarter-wave plate QWP, a first lens E1, a second lens E2, a third lens E3, and a fourth lens E4 arranged in order from a first side to a second side along a first optical axis, wherein the reflective polarizing element RP, the quarter-wave plate QWP, and the first lens E1 may belong to a first element group, a second side surface of the reflective polarizing element RP is closely fitted to a first side surface of the quarter-wave plate QWP, and a second side surface of the quarter-wave plate QWP is closely fitted to a first side surface of the first lens E1; the second lens E2 may belong to a second element group, the third lens E3 may belong to a third element group, and the fourth lens E4 may belong to a fourth element group. In this embodiment, the first optical system 100 further includes a diaphragm STO located on the first side, and an image plane IMG located on the second side.

In this embodiment, the first side may be a near-eye side, and the second side may be a display side. The image plane IMG located at the second side of the first optical system 100 may have a display screen, for example. Image light from the display screen sequentially passes through the fourth lens E4, the third lens E3, the second lens E2, the first lens E1, and the quarter-wave plate QWP to reach a near-display side surface of the reflective polarizing element RP, and is reflected for the first time at the near-display side surface of the reflective polarizing element RP. The light reflected for the first time passes through the quarter-wave plate QWP, the first lens E1, the second lens E2, the third lens E3, and the fourth lens E4 to reach a near-display side surface of the fourth lens E4, and is reflected for the second time at the near-display side surface of the fourth lens E4. The light reflected for the second time passes through the fourth lens E4, the third lens E3, the second lens E2, the first lens E1, the quarter-wave plate QWP, and the reflective polarizing element RP to reach the diaphragm STO, and is finally projected onto a target object (not shown) in the space. For example, the light reflected twice by the first optical system 100 may be finally projected into a user's eyes. A partial reflection element may be provided at the near-display side surface of the fourth lens E4, for example.

Table 1 shows basic parameters of the first optical system of Embodiment 1, wherein the units of the radius of curvature and thickness/distance are all in millimeters (mm). Image light from an image plane (display screen) sequentially passes through the respective elements in the order of surface numbers S27 to S0 and is finally projected into, for example, a human eye.

TABLE 1

| | | | | | Material | | |
|---|---|---|---|---|---|---|---|
| Surface | | Surface | Radius of | Thickness/ | Refractive | Dispersion | Refraction/ |
| No. | Element | type | curvature | distance | index | coefficient | reflection |
| S0 | | Spherical | Infinite | Infinite | | | |
| S1 | Diaphragm (STO) | Spherical | Infinite | 10.0000 | | | Refraction |
| S2 | Reflective polarizing | Spherical | Infinite | 0.2000 | 1.5000 | 57.0000 | Refraction |
| | element | | | | | | |
| S3 | Quarter-wave plate | Spherical | Infinite | 0.2000 | 1.5000 | 57.0000 | Refraction |
| | (QWP) | | | | | | |
| S4 | First lens (E1) | Spherical | 281.8603 | 1.2839 | 1.6600 | 19.9100 | Refraction |
| S5 | | Aspherical | 114.8316 | 0.2197 | | | Refraction |
| S6 | Second lens (E2) | Aspherical | −401.2641 | 3.9804 | 1.6700 | 19.0000 | Refraction |
| S7 | | Aspherical | Infinite | 0.1000 | | | Refraction |
| S8 | Third lens (E3) | Spherical | Infinite | 0.9810 | 1.6700 | 19.0000 | Refraction |
| S9 | | Spherical | 651.2893 | 0.7237 | | | Refraction |
| S10 | Fourth lens (E4) | Aspherical | −67.0659 | 4.0695 | 1.6700 | 19.0500 | Refraction |
| S11 | | Aspherical | 651.2893 | −4.0695 | 1.6700 | 19.0500 | Reflection |
| S12 | | Aspherical | Infinite | −0.7237 | | | Refraction |
| S13 | | Spherical | Infinite | −0.9810 | 1.6700 | 19.0000 | Refraction |
| S14 | | Spherical | −401.2641 | −0.1000 | | | Refraction |
| S15 | | Aspherical | 114.8316 | −3.9804 | 1.6700 | 19.0000 | Refraction |
| S16 | | Aspherical | 281.8603 | −0.2197 | | | Refraction |
| S17 | | Aspherical | Infinite | −1.2839 | 1.6600 | 19.9100 | Refraction |
| S18 | Quarter-wave plate | Spherical | Infinite | −0.2000 | 1.5000 | 57.0000 | Refraction |
| | (QWP) | | | | | | |
| S19 | Reflective polarizing | Spherical | Infinite | 0.2000 | 1.5000 | 57.0000 | Reflection |
| | element (RP) | | | | | | |
| S20 | First lens (E1) | Spherical | 281.8603 | 1.2839 | | | Refraction |
| S21 | | Aspherical | 114.8316 | 0.2197 | | | Refraction |
| S22 | Second lens (E2) | Aspherical | −401.2641 | 3.9804 | 1.6700 | 19.0000 | Refraction |
| S23 | | Aspherical | Infinite | 0.1000 | | | Refraction |
| S24 | Third lens (E3) | Spherical | Infinite | 0.9810 | 1.6700 | 19.0000 | Refraction |
| S25 | | Spherical | 651.2893 | 0.7237 | | | Refraction |
| S26 | Fourth lens (E4) | Aspherical | −67.0659 | 4.0695 | 1.6700 | 19.0500 | Refraction |
| S27 | | Aspherical | −67.7845 | 0.9313 | | | Refraction |

In this embodiment, the near-display side surface S5 of the first lens E1, the near-eye side surface S6 and the near-display side surface S7 of the second lens E2, and the near-eye side surface S10 and the near-display side surface S11 of the fourth lens E4 are all aspherical surfaces, and the surface profile of each aspherical lens can be defined by but not limited to the following aspherical surface formula:

$$x = \frac{{ch}^{2}}{1 + \sqrt{1 - ( k + 1 ) {c}^{2} {h}^{2}}} + \sum {Aih}^{i} \qquad ( 1 )$$

where x is a distance vector height from a vertex of the aspherical surface when the aspherical surface is positioned at a height of h along the direction of the optical axis; c is paraxial curvature of the aspherical surface, c=1/R′ (that is, the paraxial curvature c is the reciprocal of the radius of curvature R′ in Table 1 above); k is a conic coefficient; and Ai is a correction coefficient of an i-th order of the aspherical surface. Table 2 shows high-order coefficients A₄, A₆, A₈ and A₁₀ that can be used for each of aspherical lens surfaces S5-S7, and S10-S11 in Embodiment 1.

TABLE 2

| Surface No./coefficient | A4 | A6 | A8 | A10 |
|---|---|---|---|---|
| S5 | 3.5297E−06 | 1.1899E−08 | 1.7104E−12 | −5.3263E−14 |
| S6 | −1.9400E−06 | 2.6485E−09 | −6.3054E−13 | 0.0000E+00 |
| S7 | −2.9036E−06 | −6.5764E−10 | 1.2772E−12 | 3.4560E−14 |
| S10 | −3.4917E−06 | 8.4014E−10 | −3.9809E−13 | 0.0000E+00 |
| S11 | −2.0251E−07 | −1.0689E−09 | −2.6059E−12 | −1.6116E−15 |

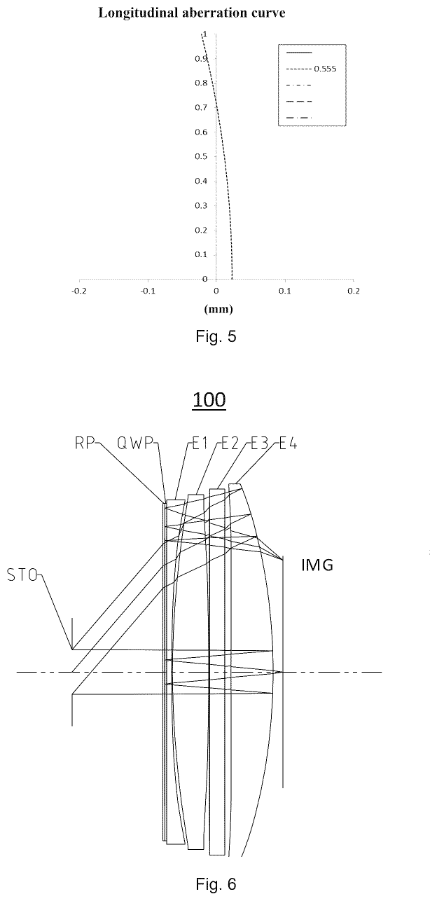

FIG. 3 shows an astigmatism curve of the first optical system of Embodiment 1, which represents the curvature of the tangential image plane and the curvature of the sagittal image plane. FIG. 4 shows a distortion curve of the first optical system of Embodiment 1, which represents distortion magnitude values corresponding to different fields of view. FIG. 5 shows a longitudinal aberration curve of the first optical system of Embodiment 1, which represents the deviation of the converged focal point of light of the respective different wavelengths after passing through the first optical system. According to FIGS. 3 to 5, it can be seen that the first optical system given in Embodiment 1 can achieve good imaging quality.

### Embodiment 2

A first optical system according to Embodiment 2 of the present application will be described below with reference to FIGS. 6 to 9.

As shown in FIG. 6, in this embodiment, the first optical system 100 also includes a reflective polarizing element RP, a quarter-wave plate QWP, a first lens E1, a second lens E2, a third lens E3, and a fourth lens E4 arranged in order from a first side to a second side along a first optical axis, wherein the reflective polarizing element RP, the quarter-wave plate QWP, and the first lens E1 may belong to a first element group, a second side surface of the reflective polarizing element RP is closely fitted to a first side surface of the quarter-wave plate QWP, and a second side surface of the quarter-wave plate QWP is closely fitted to a first side surface of the first lens E1; the second lens E2 may belong to a second element group, the third lens E3 may belong to a third element group, and the fourth lens E4 may belong to a fourth element group. In this embodiment, the first optical system 100 further includes a diaphragm STO located on the first side, and an image plane IMG located on the second side.

In this embodiment, the first side may be a near-eye side, and the second side may be a display side. The image plane IMG located at the second side of the first optical system 100 may have a display screen, for example. Image light from the display screen sequentially passes through the fourth lens E4, the third lens E3, the second lens E2, the first lens E1, and the quarter-wave plate QWP to reach a near-display side surface of the reflective polarizing element RP, and is reflected for the first time at the near-display side surface of the reflective polarizing element RP. The light reflected for the first time passes through the quarter-wave plate QWP, the first lens E1, the second lens E2, the third lens E3, and the fourth lens E4 to reach a near-display side surface of the fourth lens E4, and is reflected for the second time at the near-display side surface of the fourth lens E4. The light reflected for the second time passes through the fourth lens E4, the third lens E3, the second lens E2, the first lens E1, the quarter-wave plate QWP, and the reflective polarizing element RP to reach the diaphragm STO, and is finally projected onto a target object (not shown) in the space. For example, the light reflected twice by the first optical system 100 may be finally projected into a user's eyes. A partial reflection element may be provided at the near-display side surface of the fourth lens E4, for example.

Table 3 shows basic parameters of the first optical system of Embodiment 2, wherein the units of the radius of curvature and thickness/distance are all in millimeters (mm). Image light from an image plane (display screen) sequentially passes through the respective elements in the order of surface numbers S27 to S0 and is finally projected into, for example, a human eye.

TABLE 3

| | | | | | Material | | |
|---|---|---|---|---|---|---|---|
| Surface | | Surface | Radius of | Thickness/ | Refractive | Dispersion | Refraction/ |
| No. | Element | type | curvature | distance | index | coefficient | reflection |
| S0 | | Spherical | Infinite | Infinite | | | |
| S1 | Diaphragm (STO) | Spherical | Infinite | 10.0000 | | | Refraction |
| S2 | Reflective | Spherical | Infinite | 0.2000 | 1.5000 | 57.0000 | Refraction |
| | polarizing element | | | | | | |
| | (RP) | | | | | | |
| S3 | Quarter-wave plate | Spherical | Infinite | 0.2000 | 1.5000 | 57.0000 | Refraction |
| | (QWP) | | | | | | |
| S4 | First lens (E1) | Spherical | Infinite | 0.5523 | 1.6700 | 19.0000 | Refraction |
| S5 | | Aspherical | 205.5501 | 0.1000 | | | Refraction |
| S6 | Second lens (E2) | Aspherical | 100.9537 | 3.9804 | 1.6700 | 19.0000 | Refraction |
| S7 | | Aspherical | −490.9974 | 0.1000 | | | Refraction |
| S8 | Third lens (E3) | Spherical | Infinite | 1.6673 | 1.6700 | 19.0000 | Refraction |
| S9 | | Spherical | Infinite | 0.6640 | | | Refraction |
| S10 | Fourth lens (E4) | Aspherical | 689.8885 | 4.6613 | 1.6600 | 19.4400 | Refraction |
| S11 | | Aspherical | −66.7600 | −4.6613 | 1.6600 | 19.4400 | Reflection |
| S12 | | Aspherical | 689.8885 | −0.6640 | | | Refraction |
| S13 | | Spherical | Infinite | −1.6673 | 1.6700 | 19.0000 | Refraction |
| S14 | | Spherical | Infinite | −0.1000 | | | Refraction |
| S15 | | Aspherical | −490.9974 | −3.9804 | 1.6700 | 19.0000 | Refraction |
| S16 | | Aspherical | 100.9537 | −0.1000 | | | Refraction |
| S17 | | Aspherical | 205.5501 | −0.5523 | 1.6700 | 19.0000 | Refraction |
| S18 | Quarter-wave plate | Spherical | Infinite | −0.2000 | 1.5000 | 57.0000 | Refraction |
| | (QWP) | | | | | | |
| S19 | Reflective | Spherical | Infinite | 0.2000 | 1.5000 | 57.0000 | Reflection |
| | polarizing element | | | | | | |
| | (RP) | | | | | | |
| S20 | First lens (E1) | Spherical | Infinite | 0.5523 | | | Refraction |
| S21 | | Aspherical | 205.5501 | 0.1000 | | | Refraction |
| S22 | Second lens (E2) | Aspherical | 100.9537 | 3.9804 | 1.6700 | 19.0000 | Refraction |
| S23 | | Aspherical | −490.9974 | 0.1000 | | | Refraction |
| S24 | Third lens (E3) | Spherical | Infinite | 1.6673 | 1.6700 | 19.0000 | Refraction |
| S25 | | Spherical | Infinite | 0.6640 | | | Refraction |
| S26 | Fourth lens (E4) | Aspherical | 689.8885 | 4.6613 | 1.6600 | 19.4400 | Refraction |
| S27 | | Aspherical | −66.7600 | 1.0761 | | | Refraction |

In this embodiment, the near-display side surface S5 of the first lens E1, the near-eye side surface S6 and the near-display side surface S7 of the second lens E2, and the near-eye side surface S10 and the near-display side surface S11 of the fourth lens E4 are all aspherical surfaces, and the surface profile of each aspherical lens can be defined by formula (1) given in Embodiment 1 described above. Table 4 shows high-order coefficients A₄, A₆, A₈ and A₁₀ that can be used for each of aspherical lens surfaces S5-S7, and S10-S11 in Embodiment 2.

TABLE 4

| Surface No./coefficient | A4 | A6 | A8 | A10 |
|---|---|---|---|---|
| S5 | 2.7214E−06 | 1.2492E−08 | 2.5851E−12 | −4.9085E−14 |
| S6 | −2.0395E−06 | 2.0695E−09 | −1.3406E−12 | 0.0000E+00 |
| S7 | −2.9720E−06 | −5.6253E−10 | 1.2213E−12 | 3.5077E−14 |
| S10 | −3.1924E−06 | 9.7281E−10 | −4.3907E−13 | 0.0000E+00 |
| S11 | 2.0437E−07 | −8.7821E−10 | −2.7061E−12 | −2.1980E−15 |

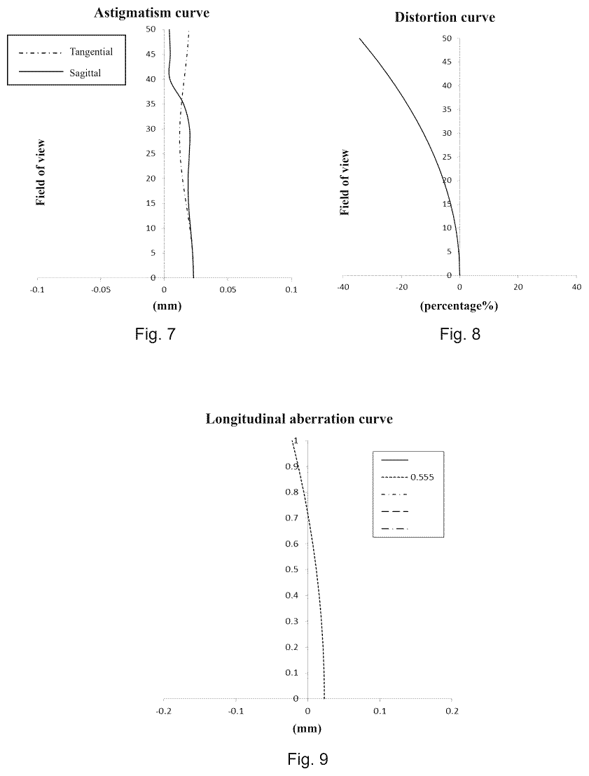

FIG. 7 shows an astigmatism curve of the first optical system of Embodiment 2, which represents the curvature of the tangential image plane and the curvature of the sagittal image plane. FIG. 8 shows a distortion curve of the first optical system of Embodiment 2, which represents distortion magnitude values corresponding to different fields of view. FIG. 9 shows a longitudinal aberration curve of the first optical system of Embodiment 2, which represents the deviation of the converged focal point of light of the respective different wavelengths after passing through the first optical system. According to FIGS. 7 to 9, it can be seen that the first optical system given in Embodiment 2 can achieve good imaging quality.

### Embodiment 3

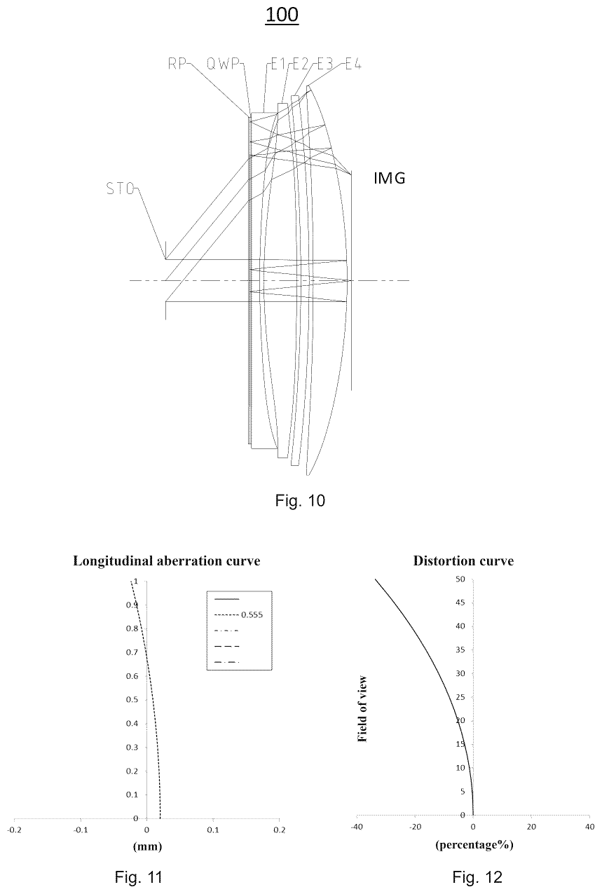

A first optical system according to Embodiment 3 of the present application will be described below with reference to FIGS. 10 to 13.

As shown in FIG. 10, in this embodiment, the first optical system 100 also includes a reflective polarizing element RP, a quarter-wave plate QWP, a first lens E1, a second lens E2, a third lens E3, and a fourth lens E4 arranged in order from a first side to a second side along a first optical axis, wherein the reflective polarizing element RP, the quarter-wave plate QWP, and the first lens E1 may belong to a first element group, a second side surface of the reflective polarizing element RP is closely fitted to a first side surface of the quarter-wave plate QWP, and a second side surface of the quarter-wave plate QWP is closely fitted to a first side surface of the first lens E1; the second lens E2 may belong to a second element group, the third lens E3 may belong to a third element group, and the fourth lens E4 may belong to a fourth element group. In this embodiment, the first optical system 100 further includes a diaphragm STO located on the first side, and an image plane IMG located on the second side.

In this embodiment, the first side may be a near-eye side, and the second side may be a display side. The image plane IMG located at the second side of the first optical system 100 may have a display screen, for example. Image light from the display screen sequentially passes through the fourth lens E4, the third lens E3, the second lens E2, the first lens E1, and the quarter-wave plate QWP to reach a near-display side surface of the reflective polarizing element RP, and is reflected for the first time at the near-display side surface of the reflective polarizing element RP. The light reflected for the first time passes through the quarter-wave plate QWP, the first lens E1, the second lens E2, the third lens E3, and the fourth lens E4 to reach a near-display side surface of the fourth lens E4, and is reflected for the second time at the near-display side surface of the fourth lens E4. The light reflected for the second time passes through the fourth lens E4, the third lens E3, the second lens E2, the first lens E1, the quarter-wave plate QWP, and the reflective polarizing element RP to reach the diaphragm STO, and is finally projected onto a target object (not shown) in the space. For example, the light reflected twice by the first optical system 100 may be finally projected into a user's eyes. A partial reflection element may be provided at the near-display side surface of the fourth lens E4, for example.

Table 5 shows basic parameters of the first optical system of Embodiment 3, wherein the units of the radius of curvature and thickness/distance are all in millimeters (mm). Image light from an image plane (display screen) sequentially passes through the respective elements in the order of surface numbers S27 to S0 and is finally projected into, for example, a human eye.

TABLE 5

| | | | | | Material | | |
|---|---|---|---|---|---|---|---|
| Surface | | Surface | Radius of | Thickness/ | Refractive | Dispersion | Refraction/ |
| No. | Element | type | curvature | distance | index | coefficient | reflection |
| S0 | | Spherical | Infinite | Infinite | | | |
| S1 | Diaphragm (STO) | Spherical | Infinite | 10.0000 | | | Refraction |
| S2 | Reflective polarizing | Spherical | Infinite | 0.2000 | 1.5000 | 57.0000 | Refraction |
| | element (RP) | | | | | | |
| S3 | Quarter-wave plate | Spherical | Infinite | 0.2000 | 1.5000 | 57.0000 | Refraction |
| | (QWP) | | | | | | |
| S4 | First lens (E1) | Spherical | Infinite | 1.0000 | 1.5900 | 27.6900 | Refraction |
| S5 | | Aspherical | 125.7822 | 0.4999 | | | Refraction |
| S6 | Second lens (E2) | Aspherical | 66.0983 | 3.9804 | 1.6700 | 19.0000 | Refraction |
| S7 | | Aspherical | 323.3335 | 0.5000 | | | Refraction |
| S8 | Third lens (E3) | Aspherical | −197.1655 | 1.0000 | 1.6700 | 19.0000 | Refraction |
| S9 | | Aspherical | −196.6777 | 0.5000 | | | Refraction |
| S10 | Fourth lens (E4) | Aspherical | −325.2522 | 4.1008 | 1.6700 | 19.0500 | Refraction |
| S11 | | Aspherical | −66.1251 | −4.1008 | 1.6700 | 19.0500 | Reflection |
| S12 | | Aspherical | −325.2522 | −0.5000 | | | Refraction |
| S13 | | Aspherical | −196.6777 | −1.0000 | 1.6700 | 19.0000 | Refraction |
| S14 | | Aspherical | −197.1655 | −0.5000 | | | Refraction |
| S15 | | Aspherical | −323.3335 | −3.9804 | 1.6700 | 19.0000 | Refraction |
| S16 | | Aspherical | 66.0983 | −0.4999 | | | Refraction |
| S17 | | Aspherical | 125.7822 | −1.0000 | 1.5900 | 27.6900 | Refraction |
| S18 | Quarter-wave plate | Spherical | Infinite | −0.2000 | 1.5000 | 57.0000 | Refraction |
| | (QWP) | | | | | | |
| S19 | Reflective polarizing | Spherical | Infinite | 0.2000 | 1.5000 | 57.0000 | Reflection |
| | element (RP) | | | | | | |
| S20 | First lens (E1) | Spherical | Infinite | 1.0000 | | | Refraction |
| S21 | | Aspherical | 125.7822 | 0.4999 | | | Refraction |
| S22 | Second lens (E2) | Aspherical | 66.0983 | 3.9804 | 1.6700 | 19.0000 | Refraction |
| S23 | | Aspherical | −323.3335 | 0.5000 | | | Refraction |
| S24 | Third lens (E3) | Aspherical | −197.1655 | 1.0000 | 1.6700 | 19.0000 | Refraction |
| S25 | | Aspherical | −196.6777 | 0.5000 | | | Refraction |
| S26 | Fourth lens (E4) | Aspherical | −325.2522 | 4.1008 | 1.6700 | 19.0500 | Refraction |
| S27 | | Aspherical | −66.1251 | 0.5000 | | | Refraction |

In this embodiment, the near-display side surface S5 of the first lens E1, the near-eye side surface S6 and the near-display side surface S7 of the second lens E2, the near-eye side surface S8 and the near-display side surface S9 of the third lens E3, and the near-eye side surface S10 and the near-display side surface S11 of the fourth lens E4 are all aspherical surfaces, and the surface profile of each aspherical lens can be defined by formula (1) given in Embodiment 1 described above. Table 6 shows high-order coefficients A₄, A₆, A₈, A₁₀ and A₁₂ that can be used for each of aspherical lens surfaces S5-S11 in Embodiment 3.

TABLE 6

| Surface No./coefficient | A4 | A6 | A8 | A10 | A12 |
|---|---|---|---|---|---|
| S5 | −1.6122E−06 | 1.0975E−08 | 5.1590E−12 | 1.5063E−14 | 0.0000E+00 |
| S6 | −6.9772E−06 | −1.5636E−09 | −7.9943E−12 | 0.0000E+00 | 0.0000E+00 |
| S7 | −1.8676E−06 | −3.2086E−09 | −8.1722E−12 | 3.1810E−14 | 0.0000E+00 |
| S8 | 6.2686E−08 | 2.0269E−10 | 4.1409E−13 | 2.4994E−16 | −3.1565E−18 |
| S9 | −4.3597E−08 | −1.6556E−10 | −3.7816E−13 | −5.3749E−16 | 4.1416E−19 |
| S10 | −1.3425E−06 | 2.5583E−09 | −4.1650E−13 | 0.0000E+00 | 0.0000E+00 |
| S11 | 3.1579E−07 | 2.1462E−11 | −2.1322E−12 | −8.9370E−15 | 0.0000E+00 |

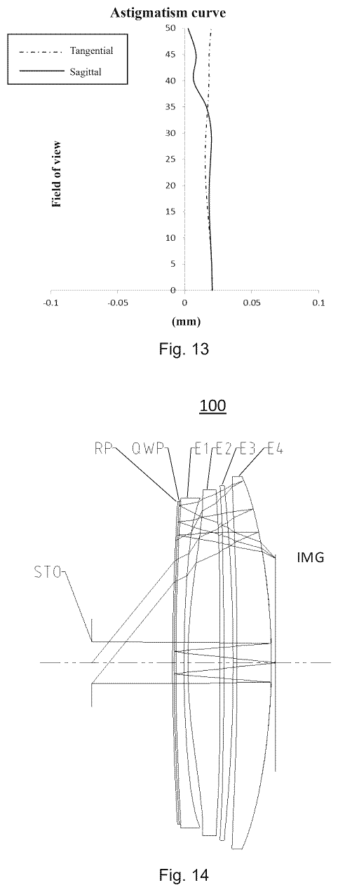

FIG. 11 shows a longitudinal aberration curve of the first optical system of Embodiment 3, which represents the deviation of the converged focal point of light of the respective different wavelengths after passing through the first optical system. FIG. 12 shows a distortion curve of the first optical system of Embodiment 3, which represents distortion magnitude values corresponding to different fields of view. FIG. 13 shows an astigmatism curve of the first optical system of Embodiment 3, which represents the curvature of the tangential image plane and the curvature of the sagittal image plane. According to FIGS. 11 to 13, it can be seen that the first optical system given in Embodiment 3 can achieve good imaging quality.

### Embodiment 4

A first optical system according to Embodiment 4 of the present application will be described below with reference to FIGS. 14 to 17.

As shown in FIG. 14, in this embodiment, the first optical system 100 also includes a reflective polarizing element RP, a quarter-wave plate QWP, a first lens E1, a second lens E2, a third lens E3, and a fourth lens E4 arranged in order from a first side to a second side along a first optical axis, wherein the reflective polarizing element RP, the quarter-wave plate QWP, and the first lens E1 may belong to a first element group, a second side surface of the reflective polarizing element RP is closely fitted to a first side surface of the quarter-wave plate QWP, and a second side surface of the quarter-wave plate QWP is closely fitted to a first side surface of the first lens E1; the second lens E2 may belong to a second element group, the third lens E3 may belong to a third element group, and the fourth lens E4 may belong to a fourth element group. In this embodiment, the first optical system 100 further includes a diaphragm STO located on the first side, and an image plane IMG located on the second side.

In this embodiment, the first side may be a near-eye side, and the second side may be a display side. The image plane IMG located at the second side of the first optical system 100 may have a display screen, for example. Image light from the display screen sequentially passes through the fourth lens E4, the third lens E3, the second lens E2, the first lens E1, and the quarter-wave plate QWP to reach a near-display side surface of the reflective polarizing element RP, and is reflected for the first time at the near-display side surface of the reflective polarizing element RP. The light reflected for the first time passes through the quarter-wave plate QWP, the first lens E1, the second lens E2, the third lens E3, and the fourth lens E4 to reach a near-display side surface of the fourth lens E4, and is reflected for the second time at the near-display side surface of the fourth lens E4. The light reflected for the second time passes through the fourth lens E4, the third lens E3, the second lens E2, the first lens E1, the quarter-wave plate QWP, and the reflective polarizing element RP to reach the diaphragm STO, and is finally projected onto a target object (not shown) in the space. For example, the light reflected twice by the first optical system 100 may be finally projected into a user's eyes. A partial reflection element may be provided at the near-display side surface of the fourth lens E4, for example.

Table 7 shows basic parameters of the first optical system of Embodiment 4, wherein the units of the radius of curvature and thickness/distance are all in millimeters (mm). Image light from an image plane (display screen) sequentially passes through the respective elements in the order of surface numbers S27 to S0 and is finally projected into, for example, a human eye.

TABLE 7

| | | | | | Material | | |
|---|---|---|---|---|---|---|---|
| Surface | | Surface | Radius of | Thickness/ | Refractive | Dispersion | Refraction/ |
| No | Element | type | curvature | distance | index | coefficient | reflection |
| S0 | | Spherical | Infinite | Infinite | | | |
| S1 | Diaphragm (STO) | Spherical | Infinite | 10.0000 | | | Refraction |
| S2 | Reflective polarizing | Aspherical | 267.2802 | 0.2000 | 1.5000 | 57.0000 | Refraction |
| | element (RP) | | | | | | |
| S3 | Quarter-wave plate | Aspherical | 267.2802 | 0.2000 | 1.5000 | 57.0000 | Refraction |
| | (QWP) | | | | | | |
| S4 | First lens (E1) | Aspherical | 267.2802 | 1.0000 | 1.6600 | 19.7700 | Refraction |
| S5 | | Aspherical | 132.8154 | 0.4999 | | | Refraction |
| S6 | Second lens (E2) | Aspherical | 62.8822 | 3.9804 | 1.6700 | 19.0000 | Refraction |
| S7 | | Aspherical | −2354.6846 | 0.5000 | | | Refraction |
| S8 | Third lens (E3) | Aspherical | −532.3586 | 1.1221 | 1.6700 | 19.0000 | Refraction |
| S9 | | Aspherical | −206.7727 | 0.5000 | | | Refraction |
| S10 | Fourth lens (E4) | Aspherical | −408.3722 | 4.2466 | 1.6500 | 20.4100 | Refraction |
| S11 | | Aspherical | −79.6816 | −4.2466 | 1.6500 | 20.4100 | Reflection |
| S12 | | Aspherical | −408.3722 | −0.5000 | | | Refraction |
| S13 | | Aspherical | −206.7727 | −1.1221 | 1.6700 | 19.0000 | Refraction |
| S14 | | Aspherical | −532.3586 | −0.5000 | | | Refraction |
| S15 | | Aspherical | −2354.6846 | −3.9804 | 1.6700 | 19.0000 | Refraction |
| S16 | | Aspherical | 62.8822 | −0.4999 | | | Refraction |
| S17 | | Aspherical | 132.8154 | −1.0000 | 1.6600 | 19.7700 | Refraction |
| S18 | Quarter-wave plate | Aspherical | 267.2802 | −0.2000 | 1.5000 | 57.0000 | Refraction |
| | (QWP) | | | | | | |
| S19 | Reflective polarizing | Aspherical | 267.2802 | 0.2000 | 1.5000 | 57.0000 | Reflection |
| | element (RP) | | | | | | |
| S20 | First lens (E1) | Aspherical | 267.2802 | 1.0000 | | | Refraction |
| S21 | | Aspherical | 132.8154 | 0.4999 | | | Refraction |
| S22 | Second lens (E2) | Aspherical | 62.8822 | 3.9804 | 1.6700 | 19.0000 | Refraction |
| S23 | | Aspherical | −2354.6846 | 0.5000 | | | Refraction |
| S24 | Third lens (E3) | Aspherical | −532.3586 | 1.1221 | 1.6700 | 19.0000 | Refraction |
| S25 | | Aspherical | −206.7727 | 0.5000 | | | Refraction |
| S26 | Fourth lens (E4) | Aspherical | −408.3722 | 4.2466 | 1.6500 | 20.4100 | Refraction |
| S27 | | Aspherical | −79.6816 | 0.5000 | | | Refraction |

In this embodiment, the near-display side surface S2 of the reflective polarizing element RP, the near-display side surface S3 of the quarter-wave plate QWP, the near-eye side surface S4 and the near-display side surface S5 of the first lens E1, the near-eye side surface S6 and the near-display side surface S7 of the second lens E2, the near-eye side surface S8 and the near-display side surface S9 of the third lens E3, and the near-eye side surface S10 and the near-display side surface S11 of the fourth lens E4 are all aspherical surfaces, and the surface profile of each aspherical lens can be defined by formula (1) given in Embodiment 1 described above. Table 8 shows high-order coefficients A₄, A₆, A₈, A₁₀, A₁₂ and A₁₄ that can be used for each of aspherical lens surfaces S2-S11 in Embodiment 4.

TABLE 8

| Surface | coefficient | | | | | |
|---|---|---|---|---|---|---|
| No. | A4 | A6 | A8 | A10 | A12 | A14 |
| S2 | −7.1107E−07 | −4.2208E−10 | 3.8974E−13 | 3.1985E−15 | 5.3051E−18 | −3.7477E−21 |
| S3 | −7.1107E−07 | −4.2208E−10 | 3.8974E−13 | 3.1985E−15 | 5.3051E−18 | −3.7477E−21 |
| S4 | −7.1107E−07 | −4.2208E−10 | 3.8974E−13 | 3.1985E−15 | 5.3051E−18 | −3.7477E−21 |
| S5 | −1.7576E−06 | 1.1155E−08 | 5.8581E−12 | 1.6095E−14 | 0.0000E+00 | 0.0000E+00 |
| S6 | −6.8915E−06 | −1.4179E−09 | −8.3455E−12 | 0.0000E+00 | 0.0000E+00 | 0.0000E+00 |
| S7 | −1.7975E−06 | −3.2839E−09 | −8.2407E−12 | 3.2358E−14 | 0.0000E+00 | 0.0000E+00 |
| S8 | 2.7638E−09 | 1.7342E−10 | 2.5928E−14 | −1.3534E−15 | −1.0255E−17 | 0.0000E+00 |
| S9 | 1.0474E−08 | −2.0065E−10 | −2.1802E−13 | 1.8373E−16 | 4.0935E−18 | 0.0000E+00 |
| S10 | −1.3542E−06 | 2.6511E−09 | −2.2902E−13 | 0.0000E+00 | 0.0000E+00 | 0.0000E+00 |
| S11 | 1.0141E−07 | −2.5262E−10 | −2.3053E−12 | −8.9827E−15 | 0.0000E+00 | 0.0000E+00 |

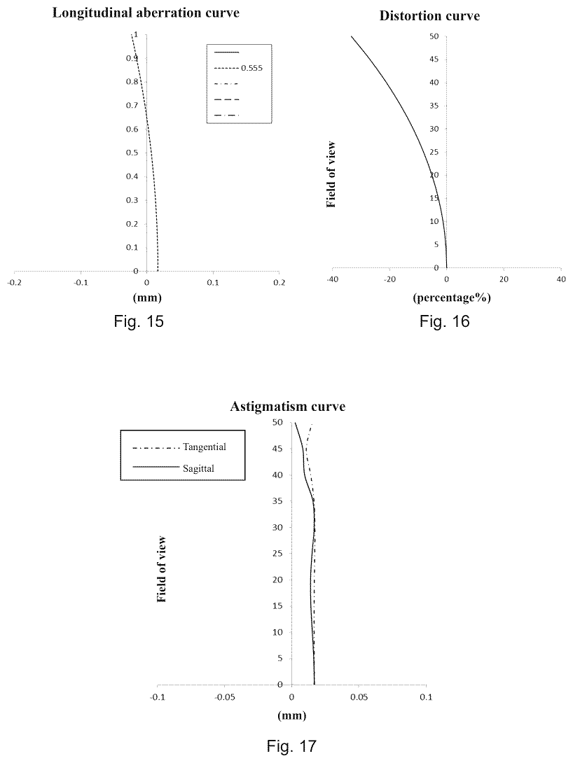

FIG. 15 shows a longitudinal aberration curve of the first optical system of Embodiment 4, which represents the deviation of the converged focal point of light of the respective different wavelengths after passing through the first optical system. FIG. 16 shows a distortion curve of the first optical system of Embodiment 4, which represents distortion magnitude values corresponding to different fields of view. FIG. 17 shows an astigmatism curve of the first optical system of Embodiment 4, which represents the curvature of the tangential image plane and the curvature of the sagittal image plane. According to FIGS. 15 to 17, it can be seen that the first optical system given in Embodiment 4 can achieve good imaging quality.

In Embodiments 1 to 4, the total optical length TTLY of the first optical system, half of the diagonal length ImgHY of the effective pixel region on the imaging plane of the first optical system, the maximum field of view FOVY of the first optical system, the entrance pupil diameter EPDY of the first optical system, the total effective focal length fy of the first optical system, the effective focal length f1Y of the first element group in the first optical system, the effective focal length f2Y of the second lens, the effective focal length f3Y of the third lens, and the effective focal length f4Y of the fourth lens are as shown in Table 9 below.

TABLE 9

| Parameter/Embodiment | Embodiment 1 | Embodiment 2 | Embodiment 3 | Embodiment 4 |
|---|---|---|---|---|
| TTLY (mm) | 12.6894 | 13.2014 | 12.4812 | 12.7490 |
| ImgHY (mm) | 12.3900 | 12.5600 | 12.5600 | 12.5600 |
| FOVY (°) | 50.0000 | 50.0000 | 50.0000 | 50.0000 |
| EPDY (mm) | 5.0000 | 5.0000 | 5.0000 | 5.0000 |
| fy (mm) | 15.7718 | 15.8832 | 15.8160 | 15.7304 |
| f1Y (mm) | −426.5962 | −302.8558 | −210.0508 | −399.5329 |
| f2Y (mm) | 131.9581 | 123.7133 | 81.1944 | 90.3003 |
| f1Y (mm) | ∞ | ∞ | 64045.9173 | 497.4454 |
| f4Y (mm) | 89.8865 | 91.1180 | 121.5127 | 149.3686 |

Specific embodiments of the second optical system applicable to the above implementations will be further described below with reference to the drawings.

### Embodiment 5

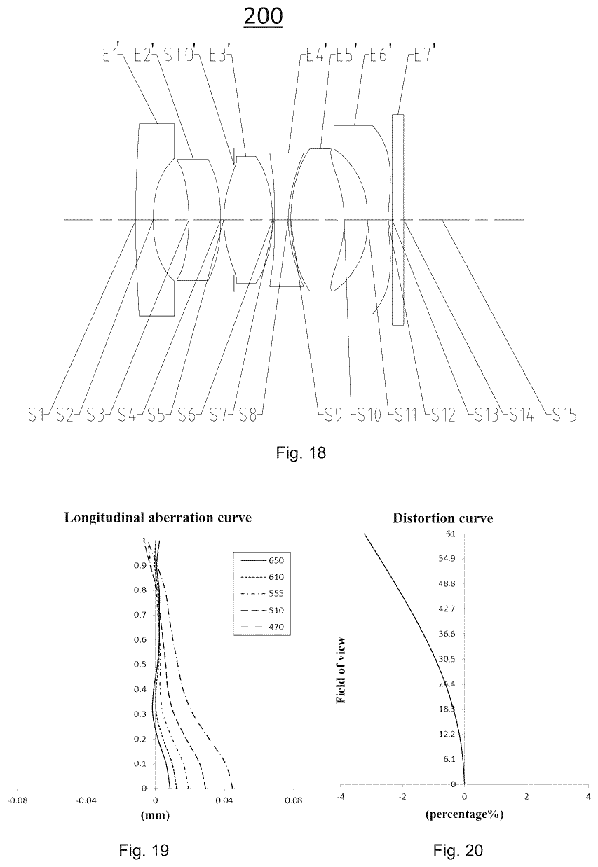

A second optical system according to Embodiment 5 of the present application will be described below with reference to FIGS. 18 to 21.

As shown in FIG. 18, the second optical system 200 includes a first lens element E1′, a second lens element E2′, a diaphragm STO′, a third lens element E3′, a fourth lens element E4′, a fifth lens element E5′, a sixth lens element E6′, a filter E7′ and an imaging plane arranged in order from an object side to an image side along a second optical axis.

In this embodiment, the first lens element E1′ has a negative refractive power, and has a concave object side surface S1 and a concave image side surface S2. The second lens element E2′ has a positive refractive power, and has a concave object side surface S3 and a convex image side surface S4. The third lens element E3′ has a positive focal power, and has a convex object side surface S5 and a convex image side surface S6. The fourth lens element E4′ has a negative refractive power, and has a convex object side surface S7 and a concave image side surface S8. The fifth lens element E5′ has a positive refractive power, and has a convex object side surface S9 and a convex image side surface S10. The sixth lens element E6′ has a negative refractive power, and has a concave object side surface S11 and a concave image side surface S12. The filter E7′ has an object side surface S13 and an image side surface S14. Light from an object passes through the respective surfaces S1 to S14 in order and is finally imaged on an imaging plane S15.

Table 10 shows basic parameters of the second optical system of Embodiment 5, wherein the units of the radius of curvature and thickness/distance are all in millimeters (mm).

TABLE 10

| | | | | Material | | Cone |
|---|---|---|---|---|---|---|
| Surface | Surface | Radius of | Thickness/ | Refractive | Dispersion | coef- |
| No. | type | curvature | distance | index | coefficient | ficient |
| OBJ | Spherical | Infinite | Infinite | | | |
| S1 | Aspherical | −111.4659 | 0.3124 | 1.55 | 56.02 | 99.0000 |
| S2 | Aspherical | 2.4731 | 0.6401 | | | 0.0000 |
| S3 | Aspherical | −2.8036 | 0.5715 | 1.65 | 23.53 | −6.0440 |
| S4 | Aspherical | −2.7022 | 0.2394 | | | 2.1291 |
| STO′ | Spherical sto | Infinite | −0.1862 | | | |
| S5 | Aspherical | 1.6643 | 0.8776 | 1.55 | 56.02 | −2.5455 |
| S6 | Aspherical | −1.9963 | 0.0300 | | | −0.3640 |
| S7 | Aspherical | 48.2648 | 0.2500 | 1.68 | 19.25 | 0.0000 |
| S8 | Aspherical | 1.4178 | 0.0446 | | | 0.0080 |
| S9 | Aspherical | 1.7647 | 0.9620 | 1.55 | 56.02 | −6.3598 |
| S10 | Aspherical | −1.8756 | 0.4151 | | | −0.1454 |
| S11 | Aspherical | −3.5312 | 0.3735 | 1.55 | 56.02 | 0.0000 |
| S12 | Aspherical | 1.7998 | 0.0725 | | | −40.2725 |
| S13 | Spherical | Infinite | 0.2100 | 1.52 | 64.17 | |
| S14 | Spherical | Infinite | 0.6974 | | | |

In this embodiment, both the object side surface and the image side surface of any lens element from the first lens element E1′ to the sixth lens element E6′ are aspherical surfaces, wherein the surface profile of each aspherical surface can be defined by formula (1) given in Embodiment 1 described above. Tables 11-1 and 11-2 show high-order coefficients A₄, A₆, A₈, A₁₀, A₁₂, A₁₄, A₁₆, A₁₈, A₂₀, A₂₂, A₂₄, A₂₆ and A₂₈ that can be used for each of the aspherical surfaces S1-S12 in Embodiment 5.

TABLE 11-1

| Surface | coefficient | | | | | | |
|---|---|---|---|---|---|---|---|
| No. | A4 | A6 | A8 | A10 | A12 | A14 | A16 |
| S1 | 8.9088E−02 | −2.6071E−02 | 1.1587E−02 | −1.7885E−03 | 2.4800E−05 | 8.6767E−05 | −4.6235E−05 |
| S2 | 1.6676E−01 | −1.3256E−04 | 1.5857E−03 | 4.6293E−04 | 9.3214E−05 | 8.6085E−05 | 2.1064E−05 |
| S3 | −5.0146E−02 | −1.3232E−02 | 2.5546E−04 | 2.0957E−04 | 1.5496E−04 | 4.0862E−05 | 1.2628E−05 |
| S4 | −2.3264E−02 | −1.5927E−03 | 1.8468E−03 | 7.1663E−05 | 1.8157E−04 | −4.4096E−07 | 1.8709E−05 |
| S5 | −1.4500E−03 | −4.5741E−03 | −1.1412E−04 | −2.6429E−04 | 6.6673E−05 | −2.7030E−05 | 1.0109E−05 |
| S6 | −9.4495E−03 | −1.3049E−02 | 3.7501E−03 | −2.0246E−03 | 5.1182E−04 | −2.4265E−04 | −4.3470E−05 |
| S7 | −1.0377E−01 | 1.1721E−02 | 3.9650E−03 | −1.0613E−03 | 1.5987E−04 | −1.0857E−04 | −1.4251E−04 |
| S8 | −2.5164E−01 | 2.8089E−02 | −1.0039E−02 | 3.0601E−03 | −1.2726E−03 | 4.2588E−04 | −3.3920E−04 |
| S9 | 5.4531E−02 | 2.5136E−02 | −7.5048E−03 | 3.9041E−03 | −1.1981E−03 | 4.6326E−04 | −2.5593E−04 |
| S10 | 1.1267E−01 | 3.4211E−02 | 1.9516E−03 | 1.4254E−03 | 3.2453E−04 | 3.8411E−04 | 9.3173E−05 |
| S11 | −4.3873E−01 | 5.0262E−02 | −2.3169E−02 | 3.5835E−03 | −6.2577E−04 | 5.3815E−04 | 8.1265E−05 |
| S12 | −5.1360E−01 | 3.3001E−02 | −1.2410E−02 | 3.8695E−03 | 8.4214E−04 | −5.4722E−04 | 4.9801E−04 |

TABLE 11-2

| Surface | coefficient | | | | | |
|---|---|---|---|---|---|---|
| No. | A18 | A20 | A22 | A24 | A26 | A28 |
| S1 | 1.8174E−05 | −1.1871E−05 | 0.0000E+00 | 0.0000E+00 | 0.0000E+00 | 0.0000E+00 |
| S2 | 2.1888E−05 | 1.4804E−06 | 9.3594E−06 | 0.0000E+00 | 0.0000E+00 | 0.0000E+00 |
| S3 | −5.6505E−06 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 |
| S5 | 0.0000E+00 | 0.0000E+00 | 0.0000E+00 | 0.0000E+00 | 0.0000E+00 | 0.0000E+00 |
| S6 | −4.1549E−05 | −3.3342E−05 | 0.0000E+00 | 0.0000E+00 | 0.0000E+00 | 0.0000E+00 |
| S7 | −1.3302E−05 | −4.1876E−05 | −2.7331E−06 | 0.0000E+00 | 0.0000E+00 | 0.0000E+00 |
| S8 | 8.0304E−05 | −7.7121E−05 | 0.0000E+00 | 0.0000E+00 | 0.0000E+00 | 0.0000E+00 |
| S9 | 9.1546E−05 | −6.6684E−05 | 0.0000E+00 | 0.0000E+00 | 0.0000E+00 | 0.0000E+00 |
| S10 | 7.3292E−05 | 1.2981E−06 | 8.8410E−06 | 0.0000E+00 | 0.0000E+00 | 0.0000E+00 |
| S11 | 3.9120E−05 | 1.9513E−05 | −4.6933E−05 | 7.2493E−07 | −2.9817E−05 | −4.0838E−06 |
| S12 | −4.1332E−04 | 2.3717E−04 | −2.0220E−04 | 7.1237E−05 | −6.0095E−05 | −1.0855E−05 |

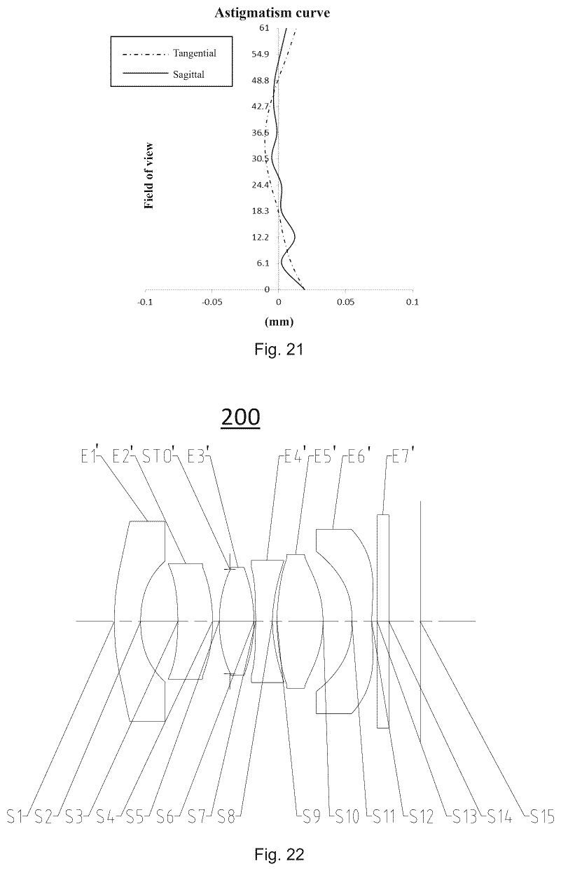

FIG. 19 shows a longitudinal aberration curve of the second optical system of Embodiment 5, which represents the deviation of the converged focal point of light of the respective different wavelengths after passing through the second optical system. FIG. 20 shows a distortion curve of the second optical system of Embodiment 5, which represents distortion magnitude values corresponding to different fields of view. FIG. 21 shows an astigmatism curve of the second optical system of Embodiment 5, which represents the curvature of the tangential image plane and the curvature of the sagittal image plane. According to FIGS. 19 to 21, it can be seen that the second optical system given in Embodiment 5 can achieve good imaging quality.

### Embodiment 6

A second optical system according to Embodiment 6 of the present application will be described below with reference to FIGS. 22 to 25.

As shown in FIG. 22, the second optical system 200 includes a first lens element E1′, a second lens element E2′, a diaphragm STO′, a third lens element E3′, a fourth lens element E4′, a fifth lens element E5′, a sixth lens element E6′, a filter E7′ and an imaging plane arranged in order from an object side to an image side along a second optical axis.

In this embodiment, the first lens element E1′ has a negative refractive power, and has a convex object side surface S1 and a concave image side surface S2. The second lens element E2′ has a positive refractive power, and has a concave object side surface S3 and a convex image side surface S4. The third lens element E3′ has a positive focal power, and has a convex object side surface S5 and a convex image side surface S6. The fourth lens element E4′ has a negative refractive power, and has a concave object side surface S7 and a concave image side surface S8. The fifth lens element E5′ has a positive refractive power, and has a convex object side surface S9 and a convex image side surface S10. The sixth lens element E6′ has a negative refractive power, and has a concave object side surface S11 and a concave image side surface S12. The filter E7′ has an object side surface S13 and an image side surface S14. Light from an object passes through the respective surfaces S1 to S14 in order and is finally imaged on an imaging plane S15.

Table 12 shows basic parameters of the second optical system of Embodiment 6, wherein the units of the radius of curvature and thickness/distance are all in millimeters (mm).

TABLE 12

| | | | | Material | | Cone |
|---|---|---|---|---|---|---|
| Surface | Surface | Radius of | Thickness/ | Refractive | Dispersion | coef- |
| No. | type | curvature | distance | index | coefficient | ficient |
| OBJ | Spherical | Infinite | Infinite | | | |
| S1 | Aspherical | 4.3440 | 0.4723 | 1.55 | 56.02 | −22.6074 |
| S2 | Aspherical | 1.6767 | 0.6712 | | | 0.0000 |
| S3 | Aspherical | −3.4575 | 0.6222 | 1.65 | 23.53 | −3.0640 |
| S4 | Aspherical | −2.4048 | 0.3113 | | | 0.9560 |
| STO′ | Spherical sto | Infinite | −0.1911 | | | |
| S5 | Aspherical | 1.9483 | 0.6254 | 1.55 | 56.02 | −1.1060 |
| S6 | Aspherical | −1.9496 | 0.0300 | | | −1.3943 |
| S7 | Aspherical | −14.2875 | 0.3000 | 1.68 | 19.25 | 0.0000 |
| S8 | Aspherical | 1.5969 | 0.0812 | | | 0.1360 |
| S9 | Aspherical | 2.1954 | 0.8292 | 1.55 | 56.02 | −11.6265 |
| S10 | Aspherical | −1.6342 | 0.5200 | | | 0.0508 |
| S11 | Aspherical | −2.1108 | 0.3546 | 1.55 | 56.02 | 0.0000 |
| S12 | Aspherical | 2.5700 | 0.1000 | | | −2.8972 |
| S13 | Spherical | Infinite | 0.2100 | 1.52 | 64.17 | |
| S14 | Spherical | Infinite | 0.5736 | | | |

In this embodiment, both the object side surface and the image side surface of any lens element from the first lens element E1′ to the sixth lens element E6′ are aspherical surfaces, wherein the surface profile of each aspherical surface can be defined by formula (1) given in Embodiment 1 described above. Tables 13-1 and 13-2 show high-order coefficients A₄, A₆, A₈, A₁₀, A₁₂, A₁₄, A₁₆, A₁₈, A₂₀, A₂₂, A₂₄, A₂₆ and A₂₈ that can be used for each of the aspherical surfaces S1-S12 in Embodiment 6.

TABLE 13-1

| Surface | coefficient | | | | | | |
|---|---|---|---|---|---|---|---|
| No. | A4 | A6 | A8 | A10 | A12 | A14 | A16 |
| S1 | 1.0200E−01 | −3.7195E−02 | 1.3502E−02 | −8.8628E−04 | −1.7722E−04 | −1.9048E−05 | 2.9909E−05 |
| S2 | 1.2442E−01 | −5.5379E−04 | 6.7038E−04 | 1.9472E−06 | 4.8816E−06 | −5.9003E−06 | −2.6442E−06 |
| S3 | −4.9492E−02 | −6.3684E−03 | 7.7284E−04 | 2.2989E−04 | 9.5159E−05 | 7.1741E−06 | 7.6723E−06 |
| S4 | −5.5722E−03 | 3.3865E−04 | 1.1076E−03 | 3.1249E−05 | 6.9040E−05 | 7.4444E−07 | 1.3922E−05 |
| S5 | 1.4606E−02 | 7.8407E−04 | 9.6732E−04 | 1.5206E−04 | 9.9032E−05 | 1.5700E−05 | 8.6917E−06 |
| S6 | 1.3859E−02 | −3.6966E−03 | 2.8181E−03 | 6.0156E−04 | −5.9035E−05 | 1.8732E−04 | −5.6110E−05 |
| S7 | −4.9315E−02 | −9.6784E−04 | 3.8284E−04 | 9.4577E−04 | −4.5366E−04 | 1.9681E−04 | −8.7424E−05 |
| S8 | −1.5553E−01 | 1.8968E−02 | −7.8090E−03 | 2.1554E−03 | −1.1089E−03 | 3.5948E−04 | −1.2767E−04 |
| S9 | −7.9680E−03 | 1.9795E−02 | −4.8628E−03 | 1.2513E−03 | −6.5874E−04 | 2.4794E−04 | −3.4818E−05 |
| S10 | 5.2836E−02 | 2.4728E−02 | 5.4235E−03 | 1.3454E−03 | 1.7722E−04 | 6.9763E−05 | 7.0852E−05 |
| S11 | −3.5116E−01 | 5.3534E−02 | −1.3585E−02 | 2.3596E−03 | −6.0820E−04 | 1.1668E−04 | −4.2448E−05 |
| S12 | −8.3825E−01 | 1.1058E−01 | −3.0690E−02 | 1.0893E−02 | −3.0166E−03 | 1.2176E−03 | −4.0419E−04 |

TABLE 13-2

| Surface | coefficient | | | | | |
|---|---|---|---|---|---|---|
| No. | A18 | A20 | A22 | A24 | A26 | A28 |
| S1 | −2.4571E−05 | −2.4143E−05 | 0.0000E+00 | 0.0000E+00 | 0.0000E+00 | 0.0000E+00 |
| S2 | 2.1245E−06 | −4.0478E−07 | −2.8660E−08 | −1.8013E−09 | 0.0000E+00 | 0.0000E+00 |
| S3 | −7.3416E−06 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 |
| S5 | 0.0000E+00 | 0.0000E+00 | 0.0000E+00 | 0.0000E+00 | 0.0000E+00 | 0.0000E+00 |
| S6 | 2.0011E−05 | −8.0031E−06 | 0.0000E+00 | 0.0000E+00 | 0.0000E+00 | 0.0000E+00 |
| S7 | 3.1081E−05 | −5.5586E−06 | 1.3219E−08 | 0.0000E+00 | 0.0000E+00 | 0.0000E+00 |
| S8 | 4.1602E−05 | −1.8411E−05 | 0.0000E+00 | 0.0000E+00 | 0.0000E+00 | 0.0000E+00 |
| S9 | 1.5238E−05 | −1.4840E−05 | 0.0000E+00 | 0.0000E+00 | 0.0000E+00 | 0.0000E+00 |
| S10 | 7.2525E−05 | 4.3248E−05 | 1.3976E−05 | 0.0000E+00 | 0.0000E+00 | 0.0000E+00 |
| S11 | −8.6353E−06 | 8.9340E−06 | −1.4969E−05 | 7.8724E−06 | −5.9160E−07 | −5.8121E−08 |
| S12 | 7.6267E−05 | −3.1248E−05 | −3.4938E−05 | 1.7715E−05 | −6.1590E−06 | 2.8493E−05 |

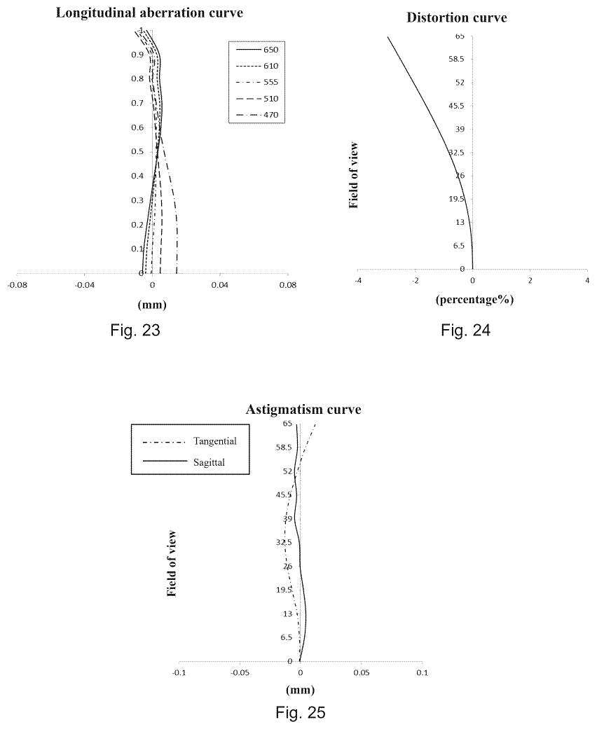

FIG. 23 shows a longitudinal aberration curve of the second optical system of Embodiment 6, which represents the deviation of the converged focal point of light of the respective different wavelengths after passing through the second optical system. FIG. 24 shows a distortion curve of the second optical system of Embodiment 6, which represents distortion magnitude values corresponding to different fields of view. FIG. 25 shows an astigmatism curve of the second optical system of Embodiment 6, which represents the curvature of the tangential image plane and the curvature of the sagittal image plane. According to FIGS. 23 to 25, it can be seen that the second optical system given in Embodiment 6 can achieve good imaging quality.

### Embodiment 7

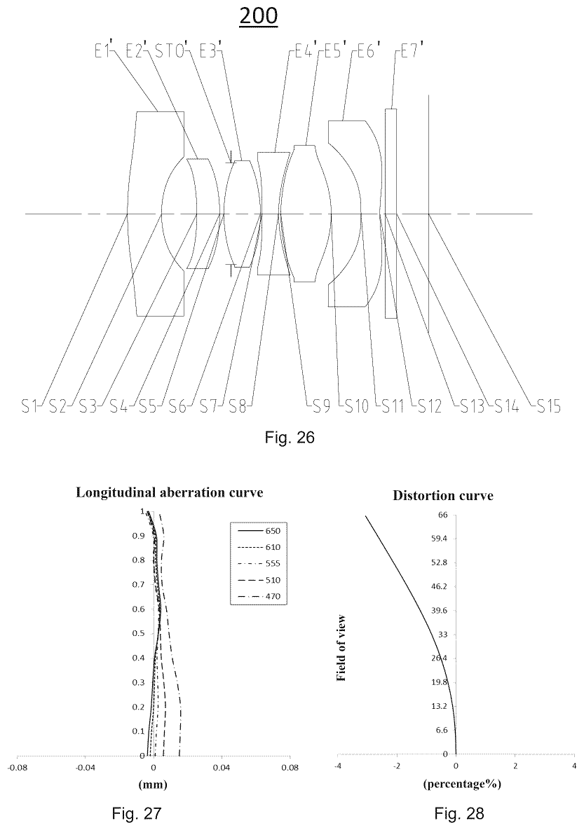

A second optical system according to Embodiment 7 of the present application will be described below with reference to FIGS. 26 to 29.

As shown in FIG. 26, the second optical system 200 includes a first lens element E1′, a second lens element E2′, a diaphragm STO′, a third lens element E3′, a fourth lens element E4′, a fifth lens element E5′, a sixth lens element E6′, a filter E7′ and an imaging plane arranged in order from an object side to an image side along a second optical axis.

In this embodiment, the first lens element E1′ has a negative refractive power, and has a convex object side surface S1 and a concave image side surface S2. The second lens element E2′ has a positive refractive power, and has a concave object side surface S3 and a convex image side surface S4. The third lens element E3′ has a positive focal power, and has a convex object side surface S5 and a convex image side surface S6. The fourth lens element E4′ has a negative refractive power, and has a concave object side surface S7 and a concave image side surface S8. The fifth lens element E5′ has a positive refractive power, and has a convex object side surface S9 and a convex image side surface S10. The sixth lens element E6′ has a negative refractive power, and has a concave object side surface S11 and a concave image side surface S12. The filter E7′ has an object side surface S13 and an image side surface S14. Light from an object passes through the respective surfaces S1 to S14 in order and is finally imaged on an imaging plane S15.

Table 14 shows basic parameters of the second optical system of Embodiment 7, wherein the units of the radius of curvature and thickness/distance are all in millimeters (mm).

TABLE 14

| | | | | Material | | Cone |
|---|---|---|---|---|---|---|
| Surface | Surface | Radius of | Thickness/ | Refractive | Dispersion | coef- |
| No. | type | curvature | distance | index | coefficient | ficient |
| OBJ | Spherical | Infinite | Infinite | | | |
| S1 | Aspherical | 4.7824 | 0.6220 | 1.55 | 56.02 | −57.6427 |
| S2 | Aspherical | 1.4885 | 0.6461 | | | 0.0000 |
| S3 | Aspherical | −3.2359 | 0.4179 | 1.65 | 23.53 | −0.2284 |
| S4 | Aspherical | −2.0743 | 0.2056 | | | 0.0660 |
| STO′ | Spherical sto | Infinite | −0.1299 | | | |
| S5 | Aspherical | 2.2292 | 0.6673 | 1.55 | 56.02 | −0.1662 |
| S6 | Aspherical | −2.0407 | 0.0300 | | | −0.0703 |
| S7 | Aspherical | −14.6362 | 0.3000 | 1.68 | 19.25 | 0.0000 |
| S8 | Aspherical | 1.5865 | 0.0412 | | | 0.0768 |
| S9 | Aspherical | 1.7545 | 0.9209 | 1.55 | 56.02 | −8.9583 |
| S10 | Aspherical | −1.6377 | 0.5452 | | | −0.1752 |
| S11 | Aspherical | −2.9821 | 0.3427 | 1.55 | 56.02 | 0.0000 |
| S12 | Aspherical | 1.9611 | 0.1000 | | | −21.3125 |
| S13 | Spherical | Infinite | 0.2100 | 1.52 | 64.17 | |
| S14 | Spherical | Infinite | 0.5911 | | | |

In this embodiment, both the object side surface and the image side surface of any lens element from the first lens element E1′ to the sixth lens element E6′ are aspherical surfaces, wherein the surface profile of each aspherical surface can be defined by formula (1) given in Embodiment 1 described above. Tables 15-1 and 15-2 show high-order coefficients A₄, A₆, A₈, A₁₀, A₁₂, A₁₄, A₁₆, A₁₈, A₂₀, A₂₂, A₂₄, A₂₆ and A₂₈ that can be used for each of the aspherical surfaces S1-S12 in Embodiment 7.

TABLE 15-1

| Surface | coefficient | | | | | | |
|---|---|---|---|---|---|---|---|
| No. | A4 | A6 | A8 | A10 | A12 | A14 | A16 |
| S1 | 3.4953E−02 | −3.0424E−02 | 1.5170E−02 | −2.5217E−03 | 2.0345E−04 | −1.1210E−04 | 5.4695E−05 |
| S2 | 7.5013E−02 | −7.4824E−04 | 2.3939E−04 | −5.9822E−06 | 3.8663E−06 | 1.7367E−06 | −1.6483E−06 |
| S3 | −4.8499E−02 | −1.1742E−02 | 3.4032E−04 | 4.4515E−04 | 1.8830E−04 | 5.2930E−05 | 7.6836E−06 |
| S4 | 2.1311E−03 | −8.1318E−03 | 2.4331E−03 | −1.9722E−04 | 2.0769E−04 | −1.8389E−05 | 2.4310E−05 |
| S5 | 2.5809E−02 | −5.1702E−03 | 1.8120E−03 | −2.9832E−04 | 1.9444E−04 | −3.2294E−05 | 1.1168E−05 |
| S6 | 1.4605E−03 | −2.1345E−03 | 1.3512E−03 | 6.1198E−04 | −2.3034E−04 | 1.9265E−04 | −7.9275E−05 |
| S7 | −6.0551E−02 | −4.8012E−05 | 1.3643E−03 | 1.0632E−03 | −5.6997E−04 | 2.4908E−04 | −1.1848E−04 |
| S8 | −1.7470E−01 | 1.9350E−02 | −9.0007E−03 | 3.1352E−03 | −1.5266E−03 | 5.5371E−04 | −2.2603E−04 |
| S9 | 1.8456E−02 | 1.8907E−02 | −9.9910E−03 | 2.4445E−03 | −1.5556E−03 | 4.3510E−04 | −2.0482E−04 |
| S10 | 1.0717E−01 | 3.1236E−02 | 1.1867E−03 | −1.6715E−03 | −1.0072E−03 | −1.4588E−04 | 8.7960E−05 |
| S11 | −4.0569E−01 | 6.1129E−02 | −1.8279E−02 | 2.8459E−03 | −1.0407E−03 | 9.0929E−05 | −9.3431E−05 |
| S12 | −5.6868E−01 | 6.2154E−02 | −1.9287E−02 | 8.2351E−03 | −1.6721E−03 | 7.1188E−04 | −2.4596E−04 |

TABLE 15-2

| Surface | coefficient | | | | | |
|---|---|---|---|---|---|---|
| No. | A18 | A20 | A22 | A24 | A26 | A28 |
| S1 | −3.7334E−05 | 4.7020E−06 | 0.0000E+00 | 0.0000E+00 | 0.0000E+00 | 0.0000E+00 |
| S2 | 3.7007E−07 | −2.2110E−08 | −1.1670E−09 | −8.4259E−11 | 0.0000E+00 | 0.0000E+00 |
| S3 | −8.8821E−06 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 |
| S5 | 0.0000E+00 | 0.0000E+00 | 0.0000E+00 | 0.0000E+00 | 0.0000E+00 | 0.0000E+00 |
| S6 | 3.0678E−05 | −5.6447E−06 | 0.0000E+00 | 0.0000E+00 | 0.0000E+00 | 0.0000E+00 |
| S7 | 5.0312E−05 | −1.6084E−05 | 4.2801E−08 | 0.0000E+00 | 0.0000E+00 | 0.0000E+00 |
| S8 | 8.4144E−05 | −4.0377E−05 | 0.0000E+00 | 0.0000E+00 | 0.0000E+00 | 0.0000E+00 |
| S9 | 8.2520E−05 | −3.4378E−05 | 0.0000E+00 | 0.0000E+00 | 0.0000E+00 | 0.0000E+00 |
| S10 | 1.2003E−04 | 5.6063E−05 | 1.5953E−05 | 0.0000E+00 | 0.0000E+00 | 0.0000E+00 |
| S11 | 6.0059E−06 | 2.1509E−05 | 3.9510E−07 | 1.9946E−05 | −2.8367E−06 | −2.4038E−07 |
| S12 | 1.3685E−06 | 1.8484E−05 | −4.6366E−05 | −2.2027E−06 | −5.4143E−06 | −1.9229E−05 |

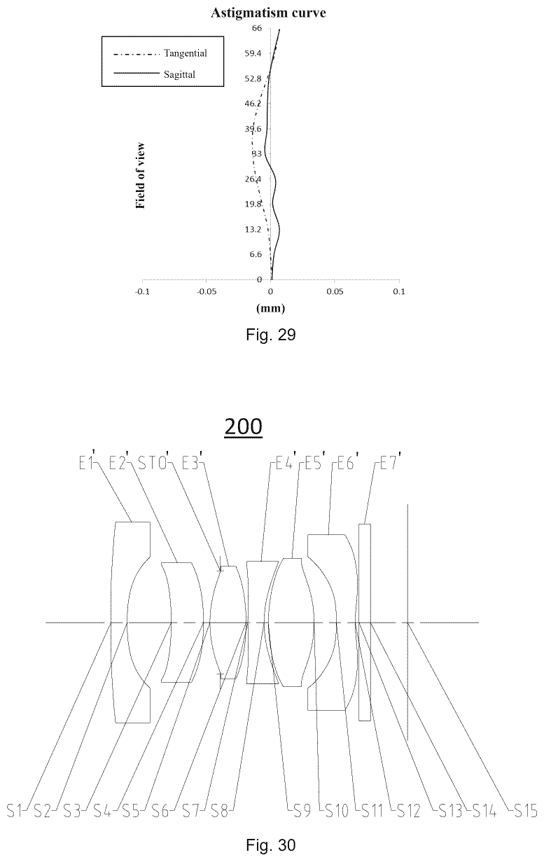

FIG. 27 shows a longitudinal aberration curve of the second optical system of Embodiment 7, which represents the deviation of the converged focal point of light of the respective different wavelengths after passing through the second optical system. FIG. 28 shows a distortion curve of the second optical system of Embodiment 7, which represents distortion magnitude values corresponding to different fields of view. FIG. 29 shows an astigmatism curve of the second optical system of Embodiment 7, which represents the curvature of the tangential image plane and the curvature of the sagittal image plane. According to FIGS. 27 to 29, it can be seen that the second optical system given in Embodiment 7 can achieve good imaging quality.

### Embodiment 8

A second optical system according to Embodiment 8 of the present application will be described below with reference to FIGS. 30 to 33.

As shown in FIG. 30, the second optical system 200 includes a first lens element E1′, a second lens element E2′, a diaphragm STO′, a third lens element E3′, a fourth lens element E4′, a fifth lens element E5′, a sixth lens element E6′, a filter E7′ and an imaging plane arranged in order from an object side to an image side along a second optical axis.

In this embodiment, the first lens element E1′ has a negative refractive power, and has a concave object side surface S1 and a concave image side surface S2. The second lens element E2′ has a positive refractive power, and has a concave object side surface S3 and a convex image side surface S4. The third lens element E3′ has a positive focal power, and has a convex object side surface S5 and a convex image side surface S6. The fourth lens element E4′ has a negative refractive power, and has a convex object side surface S7 and a concave image side surface S8. The fifth lens element E5′ has a positive refractive power, and has a convex object side surface S9 and a convex image side surface S10. The sixth lens element E6′ has a negative refractive power, and has a concave object side surface S11 and a concave image side surface S12. The filter E7′ has an object side surface S13 and an image side surface S14. Light from an object passes through the respective surfaces S1 to S14 in order and is finally imaged on an imaging plane S15.

Table 16 shows basic parameters of the second optical system of Embodiment 8, wherein the units of the radius of curvature and thickness/distance are all in millimeters (mm).

TABLE 16

| | | | | Material | | Cone |
|---|---|---|---|---|---|---|
| Surface | Surface | Radius of | Thickness/ | Refractive | Dispersion | coef- |
| No. | type | curvature | distance | index | coefficient | ficient |
| OBJ | Spherical | Infinite | Infinite | | | |
| S1 | Aspherical | −37.3713 | 0.3000 | 1.55 | 56.02 | −92.2912 |
| S2 | Aspherical | 2.9343 | 0.8184 | | | 0.0000 |
| S3 | Aspherical | −3.8660 | 0.5997 | 1.65 | 23.53 | −4.8932 |
| S4 | Aspherical | −2.8148 | 0.3111 | | | 1.8285 |
| STO′ | Spherical sto | Infinite | −0.1933 | | | |
| S5 | Aspherical | 1.8332 | 0.6722 | 1.55 | 56.02 | −1.9227 |
| S6 | Aspherical | −2.5013 | 0.0301 | | | −0.3195 |
| S7 | Aspherical | 10.0116 | 0.3000 | 1.68 | 19.25 | 0.0000 |
| S8 | Aspherical | 1.3872 | 0.0797 | | | 0.0004 |
| S9 | Aspherical | 1.8599 | 0.8489 | 1.55 | 56.02 | −6.6366 |
| S10 | Aspherical | −1.9596 | 0.4121 | | | 0.0821 |
| S11 | Aspherical | −4.9725 | 0.3500 | 1.55 | 56.02 | 0.0000 |
| S12 | Aspherical | 1.6027 | 0.0737 | | | −38.5764 |
| S13 | Spherical | Infinite | 0.2100 | 1.52 | 64.17 | |
| S14 | Spherical | Infinite | 0.6974 | | | |

In this embodiment, both the object side surface and the image side surface of any lens element from the first lens element E1′ to the sixth lens element E6′ are aspherical surfaces, wherein the surface profile of each aspherical surface can be defined by formula (1) given in Embodiment 1 described above. Tables 17-1 and 17-2 show high-order coefficients A₄, A₆, A₈, A₁₀, A₁₂, A₁₄, A₁₆, A₁₈, A₂₀, A₂₂, A₂₄, A₂₆ and A₂₈ that can be used for each of the aspherical surfaces S1-S12 in Embodiment 8.

TABLE 17-1

| Surface | coefficient | | | | | | |
|---|---|---|---|---|---|---|---|
| No. | A4 | A6 | A8 | A10 | A12 | A14 | A16 |
| S1 | 1.4679E−01 | −3.3456E−02 | 1.1837E−02 | −2.1601E−03 | 3.2928E−04 | −1.5135E−05 | 3.4576E−05 |
| S2 | 2.0685E−01 | 1.3674E−03 | 1.5780E−03 | −1.7762E−04 | −1.0929E−04 | −5.7007E−05 | −1.5334E−05 |
| S3 | −5.9204E−02 | −1.1958E−02 | −4.4801E−04 | 9.8792E−05 | 1.2124E−04 | 4.0772E−05 | 2.2322E−05 |
| S4 | −2.2040E−02 | −3.5586E−03 | 1.4414E−03 | 7.9599E−05 | 1.1940E−04 | 3.7947E−06 | 9.3941E−06 |
| S5 | 6.3404E−03 | −4.0977E−03 | −1.0526E−04 | −1.3088E−04 | 5.3425E−05 | −9.1528E−06 | 1.0351E−05 |
| S6 | −2.9601E−03 | −9.4195E−03 | 1.9005E−03 | 1.0172E−04 | −2.8497E−04 | 2.0545E−04 | −1.3366E−04 |
| S7 | −7.1483E−02 | 1.8641E−03 | 2.5963E−03 | 1.0456E−03 | −7.6372E−04 | 2.5358E−04 | −1.8666E−04 |
| S8 | −1.9143E−01 | 1.4252E−02 | −8.2050E−03 | 2.4040E−03 | −1.3784E−03 | 3.6732E−04 | −1.7214E−04 |
| S9 | 2.8652E−02 | 2.2690E−02 | −6.5154E−03 | 1.8634E−03 | −8.7593E−04 | 1.9852E−04 | −7.5999E−05 |
| S10 | 5.4387E−02 | 3.4797E−02 | 3.8725E−03 | 1.4559E−03 | −7.6911E−05 | 1.0159E−04 | 4.7769E−05 |
| S11 | −4.4782E−01 | 6.5253E−02 | −2.2528E−02 | 3.1314E−03 | −1.3094E−03 | 2.6974E−04 | 6.6305E−05 |
| S12 | −4.2575E−01 | 4.8468E−02 | −1.4248E−02 | 2.1185E−03 | 6.7173E−04 | −8.4094E−04 | 7.2806E−04 |

TABLE 17-2

| Surface | coefficient | | | | | |
|---|---|---|---|---|---|---|
| No. | A18 | A20 | A22 | A24 | A26 | A28 |
| S1 | −4.4021E−06 | 2.0478E−05 | 0.0000E+00 | 0.0000E+00 | 0.0000E+00 | 0.0000E+00 |
| S2 | −7.9635E−06 | −7.5765E−06 | −6.3116E−07 | −3.6112E−08 | 0.0000E+00 | 0.0000E+00 |
| S3 | 1.1453E−06 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 |
| S5 | 0.0000E+00 | 0.0000E+00 | 0.0000E+00 | 0.0000E+00 | 0.0000E+00 | 0.0000E+00 |
| S6 | 4.9312E−05 | −3.2622E−05 | 0.0000E+00 | 0.0000E+00 | 0.0000E+00 | 0.0000E+00 |
| S7 | 4.7129E−05 | −4.1312E−05 | 1.2155E−07 | 0.0000E+00 | 0.0000E+00 | 0.0000E+00 |
| S8 | 3.8260E−05 | −2.1003E−05 | 0.0000E+00 | 0.0000E+00 | 0.0000E+00 | 0.0000E+00 |
| S9 | 3.1767E−06 | −1.7089E−05 | 0.0000E+00 | 0.0000E+00 | 0.0000E+00 | 0.0000E+00 |
| S10 | 9.4529E−05 | 4.3872E−05 | 2.4513E−05 | 0.0000E+00 | 0.0000E+00 | 0.0000E+00 |
| S11 | 1.7046E−04 | 1.1721E−04 | 4.6624E−05 | 3.1773E−05 | −7.8647E−06 | −6.1504E−07 |
| S12 | −3.6025E−04 | 2.8433E−04 | −1.6021E−04 | 8.4214E−05 | −6.1860E−05 | 2.9494E−05 |

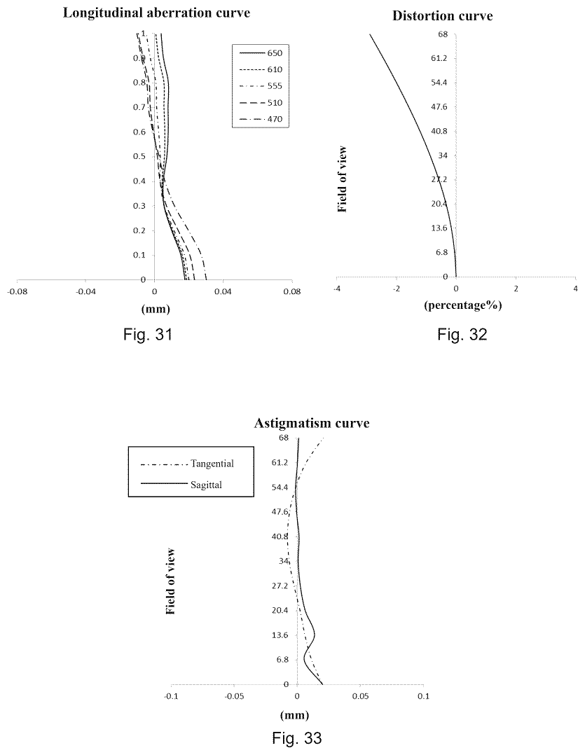

FIG. 31 shows a longitudinal aberration curve of the second optical system of Embodiment 8, which represents the deviation of the converged focal point of light of the respective different wavelengths after passing through the second optical system. FIG. 32 shows a distortion curve of the second optical system of Embodiment 8, which represents distortion magnitude values corresponding to different fields of view. FIG. 33 shows an astigmatism curve of the second optical system of Embodiment 8, which represents the curvature of the tangential image plane and the curvature of the sagittal image plane. According to FIGS. 31 to 33, it can be seen that the second optical system given in Embodiment 8 can achieve good imaging quality.

In addition, in Embodiments 5 to 8, the total optical length TTLX of the second optical system (i.e., the axial distance from the object side surface of the first lens element E1′ to the imaging plane of the second optical system), half of the diagonal length ImgHX of the effective pixel region on the imaging plane of the second optical system, the maximum field of view FOVX of the second optical system, the entrance pupil diameter EPDX of the second optical system, the total effective focal length fx of the second optical system, the effective focal lengths f1x to f6x of the first lens element E1′ to the sixth lens element E6′ in the second optical system, and the combined focal length f56x of the fifth lens element E′ and the sixth lens element E6′ are as shown in Table 18 below.

TABLE 18

| Parameter/Embodiment | Embodiment 5 | Embodiment 6 | Embodiment 7 | Embodiment 8 |
|---|---|---|---|---|
| TTLX (mm) | 5.4894 | 5.4898 | 5.4898 | 5.4902 |
| ImgHX (mm) | 1.8550 | 1.9550 | 1.9550 | 1.9811 |
| FOVX (°) | 61.0000 | 64.7417 | 65.6790 | 68.0000 |
| EPDX (mm) | 1.2386 | 1.2447 | 1.2500 | 1.2111 |
| fx (mm) | 2.2361 | 2.2474 | 2.2574 | 2.1880 |
| f1x (mm) | −4.4247 | −5.3324 | −4.2388 | −4.9673 |
| f2x (mm) | 36.1114 | 9.9485 | 7.8563 | 13.1254 |
| f3x (mm) | 1.8152 | 1.8910 | 2.0643 | 2.0488 |
| f4x (mm) | −2.1605 | −2.1038 | −2.0969 | −2.4107 |
| f5x (mm) | 1.8358 | 1.8571 | 1.7151 | 1.8956 |
| f6x (mm) | −2.1296 | −2.0662 | −2.1139 | −2.1778 |
| f56X (mm) | 3.2080 | 3.5605 | 2.6035 | 3.5346 |

Referring to FIG. 1, the virtual reality system 10 provided by the present application may include the first optical system 100 given in any one of Embodiments 1 to 4 described above and the second optical system 200 given in any one of Embodiments 5 to 8 described above. The embodiments of the above first optical system 100 may be combined with the embodiments of the above second optical system 200 in pairs in 16 ways, that is, the virtual reality system 10 may have 16 different examples. Table 19 below shows conditions satisfied by four virtual reality systems of Examples 1 to 4, wherein the virtual reality system corresponding to Example 1 includes the first optical system of Embodiment 1 and the second optical system of Embodiment 5, the virtual reality system corresponding to Example 2 includes the first optical system of Embodiment 2 and the second optical system of Embodiment 6, the virtual reality system corresponding to Example 3 includes the first optical system of Embodiment 3 and the second optical system of Embodiment 7, and the virtual reality system corresponding to Example 4 includes the first optical system of Embodiment 4 and the second optical system of Embodiment 8.

TABLE 19

| Conditional Expression/Example | Example 1 | Example 2 | Example 3 | Example 4 |
|---|---|---|---|---|
| Semi-FOVX/Semi-FOVY | 1.2200 | 1.2948 | 1.3136 | 1.3600 |
| TDY/TDX | 2.5956 | 2.6210 | 2.5995 | 2.7046 |
| ΣATX/ΣATY | 1.1338 | 1.6466 | 0.8922 | 0.9721 |
| ΣCTY/ΣCTX | 3.0817 | 3.3901 | 3.0823 | 3.3701 |
| CT1Y/(CTRA + CTQA) | 3.2096 | 1.3808 | 2.5000 | 2.5000 |
| f2X/R3X | −12.8802 | −2.8774 | −2.4278 | −3.3951 |
| R3X/R4X | 1.0376 | 1.4378 | 1.5600 | 1.3734 |
| CT4Y/CT3Y | 4.1485 | 2.7957 | 4.1008 | 3.7846 |
| f6x/R11X | 0.603 | 0.979 | 0.709 | 0.438 |
| f6x/R12X | −1.1833 | −0.8040 | −1.0779 | −1.3588 |
| f2y/f4y | 1.4681 | 1.3577 | 0.6682 | 0.6045 |
| CT5X/(T56X + CT6X) | 1.2198 | 0.9481 | 1.0372 | 1.1140 |
| f56X/f4X | −1.4848 | −1.6924 | −1.2416 | −1.4662 |
| EPDY/EPDX | 4.0368 | 4.0170 | 4.0000 | 4.1285 |
| f5x/CT5X | 1.9083 | 2.2395 | 1.8624 | 2.2329 |
| CT2Y/(T12Y + T23Y) | 12.4521 | 19.9022 | 3.9808 | 3.9809 |
| f3X/CT3X | 2.0684 | 3.0237 | 3.0935 | 3.0478 |
| R5X/R6X | −0.8337 | −0.9994 | −1.0924 | −0.7329 |

In an exemplary implementation, the virtual reality system provided by the present application may include not only the first optical system and the second optical system as described above, but also one or more other optical systems, for example, a third optical system, a fourth optical system, etc. That is, there may be two, three or more optical systems in the virtual reality system provided by the present application. Referring to FIG. 1, in an exemplary implementation, the virtual reality system 10 provided by the present application may include a first optical system 100 and a second optical system 200, and may further include a third optical system 300.

In an exemplary implementation, the virtual reality system provided by the present application may include one second optical system 200, or may include two or more second optical systems 200 as needed. In some implementations, the third optical system 300 as shown in FIG. 1 may also be another second optical system 200, for example.

The above description represents only the preferred embodiments of the present application and the explanation of the applied technical principle. It should be understood by those skilled in the art that the scope of disclosure involved in the present application is not limited to technical solutions formed by specific combinations of the above technical features, and at the same time, should also cover other technical solutions formed by any combination of the above technical features or equivalent features thereof without departing from the concept of the disclosure. For example, the above features and (but not limited to) the technical features with similar functions disclosed in the present application are replaced with each other to form technical solutions.

What is claimed is:

1. A virtual reality system, comprising a first optical system and a second optical system, wherein:
the first optical system comprises a first element group, a second element group, a third element group and a fourth element group in order from a first side to a second side along a first optical axis, wherein the first element group comprises a reflective polarizing element, a quarter-wave plate and a first lens having a negative refractive power; the second element group comprises a second lens having a positive refractive power; the third element group comprises a third lens; the fourth element group comprises a fourth lens having a positive refractive power; the number of lenses having a refractive power in the first optical system is four;
the second optical system comprises a first lens element, a second lens element, a third lens element, a fourth lens element, a fifth lens element and a sixth lens element in order from an object side to an image side along a second optical axis, wherein the first lens element, the fourth lens element and the sixth lens element have a negative refractive power;
the second lens element, the third lens element and the fifth lens element have a positive refractive power; the number of lenses having a refractive power in the second optical system is six; and
the virtual reality system satisfies:
$$1. 2200 \leq F OVX / FOVY \leq 1.36 ,$$
wherein FOVX is a maximum field of view of the second optical system, and FOVY is a maximum field of view of the first optical system.

2. The virtual reality system according to claim 1, wherein a sum ΣCTY of center thicknesses of the first lens, the second lens, the third lens and the fourth lens in the first optical system on the first optical axis and a sum ΣCTX of center thicknesses of the first lens element, the second lens element, the third lens element, the fourth lens element, the fifth lens element and the sixth lens element in the second optical system on the second optical axis satisfy:
$$3.0817 \leq Σ CTY / Σ CTX \leq 3 \text{.3901} ;$$
and/or
wherein a center thickness CT1Y of the first lens in the first optical system on the first optical axis, a center thickness CTRA of the reflective polarizing element in the first optical system on the first optical axis, and a center thickness CTQA of the quarter-wave plate in the first optical system on the first optical axis satisfy:
$$1.3808 \leq CT 1 Y / ( CTRA + CTQA ) \leq 3 \text{.2096} ;$$
and/or
wherein among the first to fourth lenses of the first optical system, the fourth lens has the largest center thickness on the first optical axis, and the center thickness CT4Y of the fourth lens on the first optical axis and a center thickness CT3Y of the third lens on the first optical axis satisfy:
$$2.7957 ⩽ CT 4 Y / CT 3 Y ⩽ 4.148 5 .$$

3. The virtual reality system according to claim 1, wherein a radius of curvature R3X of an object side surface of the second lens element in the second optical system, a radius of curvature R4X of an image side surface of the second lens element in the second optical system, and an effective focal length f2X of the second lens element in the second optical system satisfy:
$$\begin{matrix}1.0376 \leq R 3 X / R 4 X \leq 1.56 , and \\ - 12. 8802 \leq f 2 X / R 3 X \leq - 2.4278 .\end{matrix}$$

4. The virtual reality system according to claim 1, wherein in the second optical system, an effective focal length f6X of the sixth lens element, a radius of curvature R11X of an object side surface of the sixth lens element, and a radius of curvature R12X of an image side surface of the sixth lens element satisfy:
$$\begin{matrix}0.438 \leq f 6 X / R 11 X \leq 0.9 \; 79 , and \\ - 1.3588 \leq f 6 X / R 12 X \leq - 0.8040 .\end{matrix}$$

5. The virtual reality system according to claim 1, wherein an effective focal length f2Y of the second lens and an effective focal length f4Y of the fourth lens in the first optical system satisfy:
0.6045≤f2Y/f4Y≤1.4681; and/or
wherein in the first optical system, a center thickness CT2Y of the second lens on the first optical axis, an air spacing T12Y between the first lens and the second lens on the first optical axis, and an air spacing T23Y between the second lens and the third lens on the first optical axis satisfy:
$$3.9808 ⩽ CT 2 Y / ( T 12 Y + T 23 Y ) ⩽ 19. 9022 .$$

6. The virtual reality system according to claim 1, wherein a dispersion coefficient VNY of any lens among the first to fourth lenses of the first optical system satisfies:
$$15 < VNY < 30.$$

7. The virtual reality system according to claim 1, wherein among the first to sixth lens elements of the second optical system, the fifth lens element has the largest center thickness on the second optical axis, and the center thickness CT5X of the fifth lens element on the second optical axis, an air spacing T56X between the fifth lens element and the sixth lens element on the second optical axis, and a center thickness CT6X of the sixth lens element on the second optical axis satisfy:
$$0.9481 \leq CT 5 X / ( T 56 X + C T 6 X ) \leq 1.2198 ;$$
wherein a combined focal length f56X of the fifth lens element and the sixth lens element in the second optical system, and an effective focal length f4X of the fourth lens element satisfy:
$$- 1.6924 \leq f 56 X / f 4 X \leq - 1.2416 ;$$
wherein an effective focal length f5X of the fifth lens element in the second optical system and a center thickness CT5X of the fifth lens element on the second optical axis satisfy:
$$1. 8 \; 624 ⩽ f 5 X / CT 5 X ⩽ 2.239 5 .$$

8. The virtual reality system according to claim 1, wherein an entrance pupil diameter EPDY of the first optical system and an entrance pupil diameter EPDX of the second optical system satisfy:
$$4. 0000 \leq E PDY / EPDX \leq 4.1285 .$$

9. The virtual reality system according to claim 1, wherein in the second optical system, an effective focal length f3X of the third lens element, a center thickness CT3X of the third lens element on the second optical axis, a radius of curvature R5X of an object side surface of the third lens element and a radius of curvature R6X of an image side surface of the third lens element satisfy:
$$\begin{matrix}2.0684 \leq f 3 X / CT 3 X \leq 3.0 \; 935 , and \\ - 1.0924 \leq R 5 X / R 6 X \leq - 0.7329 .\end{matrix}$$

10. The virtual reality system according to claim 1, wherein in the first optical system, a first side surface of the first lens is closely fitted to the quarter-wave plate, and a second side surface of the reflective polarizing element is closely fitted to the quarter-wave plate.

11. A virtual reality system, comprising a first optical system and a second optical system, wherein:
the first optical system comprises a first element group, a second element group, a third element group and a fourth element group in order from a first side to a second side along a first optical axis, wherein the first element group comprises a reflective polarizing element, a quarter-wave plate and a first lens having a negative refractive power; the second element group comprises a second lens having a positive refractive power; the third element group comprises a third lens; the fourth element group comprises a fourth lens having a positive refractive power; the number of lenses having a refractive power in the first optical system is four;
the second optical system comprises a first lens element, a second lens element, a third lens element, a fourth lens element, a fifth lens element and a sixth lens element in order from an object side to an image side along a second optical axis, wherein the first lens element, the fourth lens element and the sixth lens element have a negative refractive power;
the second lens element, the third lens element and the fifth lens element have a positive refractive power; the number of lenses having a refractive power in the second optical system is six; and
the virtual reality system satisfies:
$$\begin{matrix}2.5956 \leq TDY / TDX \leq 2.7 \; 046 , and \\ 0.8922 \leq Σ ATX / Σ ATY \leq 1.6466 ,\end{matrix}$$
where TDY is a distance from a first side surface of the first element group in the first optical system to a second side surface of the fourth element group on the first optical axis, TDX is a distance from an object side surface of the first lens element in the second optical system to an image side surface of the sixth lens element on the second optical axis, ΣATY is a sum of air spacings between any two adjacent lenses having a refractive power in the first optical system on the first optical axis, and ΣATX is a sum of air spacings between any two adjacent lens elements having a refractive power in the second optical system on the second optical axis.

12. The virtual reality system according to claim 11, wherein a sum ΣCTY of center thicknesses of the first lens, the second lens, the third lens and the fourth lens in the first optical system on the first optical axis and a sum ΣCTX of center thicknesses of the first lens element, the second lens element, the third lens element, the fourth lens element, the fifth lens element and the sixth lens element in the second optical system on the second optical axis satisfy:
$$3.0817 \leq Σ CTY / Σ CTX \leq 3 \text{.3901} ;$$
wherein a center thickness CT1Y of the first lens in the first optical system on the first optical axis, a center thickness CTRA of the reflective polarizing element in the first optical system on the first optical axis, and a center thickness CTQA of the quarter-wave plate in the first optical system on the first optical axis satisfy:
$$1.3808 \leq CT 1 Y / ( CTRA + CTQA ) \leq 3.2096 ;$$
wherein among the first to fourth lenses of the first optical system, the fourth lens has the largest center thickness on the first optical axis, and the center thickness CT4Y of the fourth lens on the first optical axis and a center thickness CT3Y of the third lens on the first optical axis satisfy:
$$2.7957 ⩽ CT 4 Y / CT 3 Y ⩽ 4.1485 .$$

13. The virtual reality system according to claim 11, wherein a radius of curvature R3X of an object side surface of the second lens element in the second optical system, a radius of curvature R4X of an image side surface of the second lens element in the second optical system, and an effective focal length f2X of the second lens element in the second optical system satisfy:
$$1.0376 \leq R 3 X / R 4 X \leq 1.56 , and$$
$$- 12.8802 \leq f 2 X / R 3 X \leq - 2.4278 .$$

14. The virtual reality system according to claim 11, wherein in the second optical system, an effective focal length f6X of the sixth lens element, a radius of curvature R11X of an object side surface of the sixth lens element, and a radius of curvature R12X of an image side surface of the sixth lens element satisfy:
$$0.438 \leq f 6 X / R 11 X \leq 0.979 , and$$
$$- 1.3588 \leq f 6 X / R 12 X \leq - 0.804 .$$

15. The virtual reality system according to claim 11, wherein an effective focal length f2Y of the second lens and an effective focal length f4Y of the fourth lens in the first optical system satisfy:
$$0.6045 \leq f 2 Y / f 4 Y \leq 1.4681 ;$$
wherein in the first optical system, a center thickness CT2Y of the second lens on the first optical axis, an air spacing T12Y between the first lens and the second lens on the first optical axis, and an air spacing T23Y between the second lens and the third lens on the first optical axis satisfy:
$$3.9808 ⩽ CT 2 Y / ( T 12 Y + T 23 Y ) ⩽ 19.9022 .$$

16. The virtual reality system according to claim 11, wherein a dispersion coefficient VNY of any lens in the first optical system satisfies:
$$15 < VNY < 30.$$

17. The virtual reality system according to claim 11, wherein among the first to sixth lens elements of the second optical system, the fifth lens element has the largest center thickness on the second optical axis, and the center thickness CT5X of the fifth lens element on the second optical axis, an air spacing T56X between the fifth lens element and the sixth lens element on the second optical axis, and a center thickness CT6X of the sixth lens element on the second optical axis satisfy:
$$0.9481 \leq CT 5 X / ( T 56 X + CT 6 X ) \leq 1.2198 ;$$
wherein a combined focal length f56X of the fifth lens element and the sixth lens element in the second optical system, and an effective focal length f4X of the fourth lens element satisfy:
$$- 1.6924 \leq f 56 X / f 4 X \leq - 1.2416 ;$$
wherein an effective focal length f5X of the fifth lens element in the second optical system and a center thickness CT5X of the fifth lens element on the second optical axis satisfy:
$$1.8624 ⩽ f 5 X / CT 5 X ⩽ 2.2395 .$$

18. The virtual reality system according to claim 11, wherein an entrance pupil diameter EPDY of the first optical system and an entrance pupil diameter EPDX of the second optical system satisfy:
4.0000≤EPDY/EPDX≤4.1285.

19. The virtual reality system according to claim 11, wherein in the second optical system, an effective focal length f3X of the third lens element, a center thickness CT3X of the third lens element on the second optical axis, a radius of curvature R5X of an object side surface of the third lens element and a radius of curvature R6X of an image side surface of the third lens element satisfy:
$$2.0684 \leq f 3 X / CT 3 X \leq 3.0935 , and$$
$$- 1.0924 \leq R 5 X / R 6 X \leq - 0.7329 .$$

20. The virtual reality system according to claim 11, wherein in the first optical system, a first side surface of the first lens is closely fitted to the quarter-wave plate, and a second side surface of the reflective polarizing element is closely fitted to the quarter-wave plate.
